(19) United States
(12) Patent Application Publication
(10) Pub. No.: US 2025/0118841 A1
(43) Pub. Date: Apr. 10, 2025

(54) BATTERY PACKAGE AND BATTERY MODULE

(71) Applicant: KYOCERA Corporation, Kyoto-shi, Kyoto (JP)

(72) Inventor: Koutarou NAKAMOTO, Kyoto-shi (JP)

(73) Assignee: KYOCERA Corporation, Kyoto-shi, Kyoto (JP)

(21) Appl. No.: 18/729,268

(22) PCT Filed: Jan. 13, 2023
(86) PCT No.: PCT/JP2023/000782

§ 371 Date: Jul. 16, 2024

(30) Foreign Application Priority Data
Jan. 21, 2022 (JP) 2022-008267

(51) Int. Cl. H01M 50/222; H01M 50/107; H01M 50/202; H01M 50/298

(52) U.S. Cl. CPC H01M 50/222; H01M 50/107; H01M 50/202; H01M 50/298

(57) ABSTRACT

To reduce the size of a battery module while improving assemblability of the battery module. A battery package includes an insulating substrate having a first surface, a second surface located opposite to the first surface, and a recessed portion. The battery package includes a first external electrode located on the second surface and a second external electrode located on the second surface. The battery package includes a first electrode located on an inner side surface of the recessed portion and electrically connected to the first external electrode, and a second electrode located on the inner side surface of the recessed portion and electrically connected to the second external electrode.

### TECHNICAL FIELD

The present disclosure relates to a battery package for mounting a cylinder-type or laminate-type battery, and a battery module.

### BACKGROUND OF INVENTION

In general, a cylinder-type battery has a linear lead terminal. Therefore, it has been difficult to perform surface mount technology of the cylinder-type battery on the mounting substrate. In recent years, the surface mount technology of the cylinder-type battery on a mounting substrate after mounting the cylinder-type battery in a package has been studied.

For example, in a technique described in Patent Document 1, an electronic component is mounted on a package in a state where the linear lead terminal of the electronic component is placed on an electrode (referred to as a bonding portion of an external electrode terminal in Patent Document 1) of the package.

### CITATION LIST

### Patent Literature

Patent Document 1: JP 2007-67644 A

### SUMMARY

A battery package according to the present disclosure includes: an insulating substrate including a first surface, a second surface located opposite to the first surface, and a recessed portion exposed in the first surface; a first external electrode located on the second surface; a second external electrode located on the second surface; a first electrode located on an inner side surface of the recessed portion and electrically connected to the first external electrode; and a second electrode located on the inner side surface of the recessed portion and electrically connected to the second external electrode.

A battery module according to the present disclosure includes: the battery package; and a cylinder-type or laminate-type battery accommodated in the recessed portion. The battery includes a first lead terminal electrically connected to the first electrode in a bent state, and a second lead terminal electrically connected to the second electrode in a bent state.

### BRIEF DESCRIPTION OF THE DRAWINGS

FIG. 1 includes a cross-sectional view and a plan view illustrating a battery module according to a first embodiment.

FIG. 2 includes a cross-sectional view and a plan view illustrating a battery module according to another aspect of the first embodiment.

FIG. 3 is a schematic cross-sectional view illustrating the battery module according to another aspect of the first embodiment.

FIG. 4 is a schematic cross-sectional view illustrating the battery module according to another aspect of the first embodiment.

FIG. 5 is a schematic cross-sectional view illustrating the battery module according to another aspect of the first embodiment.

FIG. 6 includes a cross-sectional view and a plan view illustrating a battery module according to a second embodiment.

FIG. 7 is a schematic cross-sectional view illustrating a battery module according to another aspect of the second embodiment.

FIG. 8 includes a cross-sectional view and a plan view illustrating a battery module according to a third embodiment.

FIG. 9 includes a cross-sectional view and a plan view illustrating a battery module according to another aspect of the third embodiment.

FIG. 10 includes a cross-sectional view and a plan view illustrating a battery module according to a fourth embodiment.

FIG. 11 includes a cross-sectional view and a plan view illustrating a battery module according to a fifth embodiment.

FIG. 12 includes a cross-sectional view and a plan view illustrating a battery module according to a sixth embodiment.

FIG. 13 is a schematic cross-sectional view illustrating a battery module according to another aspect of the sixth embodiment.

FIG. 14 is a schematic cross-sectional view illustrating the battery module according to another aspect of the sixth embodiment.

FIG. 15 includes a cross-sectional view and a plan view illustrating a battery module according to a seventh embodiment.

FIG. 16 is a cross-sectional view illustrating a battery module according to another embodiment.

### DESCRIPTION OF EMBODIMENTS

When the technique described in Patent Document 1 is applied to a package in which a cylinder-type battery is mounted, adjustment of the height of a bonding portion between a lead terminal of the battery and an electrode of the package is needed. Therefore, the assembly of the battery module including the cylinder-type battery and the package becomes complicated, and there is a concern that the assemblability of the battery module may decrease.

When the battery is mounted on the package in a state where the lead terminal of the cylinder-type battery is placed on the electrode of the package, the package becomes large in a plan view. Therefore, there is concern about an increase in the size of the package, in other words, an increase in the size of the battery module.

Even when a laminate-type battery including a lead terminal having a plate shape is mounted in a package in place of the cylinder-type battery, the same problems as described above may occur.

According to the present disclosure, the size of a battery module can be reduced while improving the assemblability of the battery module.

Hereinafter, a battery package and a battery module according to an embodiment will be described in detail with reference to the drawings. However, each of the figures, which will be referred to below, is a simplified representation of only components necessary for description of the embodiments, for convenience of description. Therefore, the battery package and the battery module according to the embodiment may include arbitrary constituent elements that are not illustrated in the drawings to be referred to. The dimensions of the components in the drawings may not faithfully represent the actual dimensions of the components, the dimension ratios of the members, or the like. In the present disclosure, the lateral direction refers to a direction orthogonal to the thickness direction of the insulating substrate, in other words, a direction orthogonal to the depth direction of the recessed portion of the insulating substrate. The term “pressure contact” means contact with a pressure. The rectangular shape is not limited to a strictly rectangular shape, and includes a shape that can be visually recognized as a rectangular shape as a whole even when, for example, a corner portion is curved.

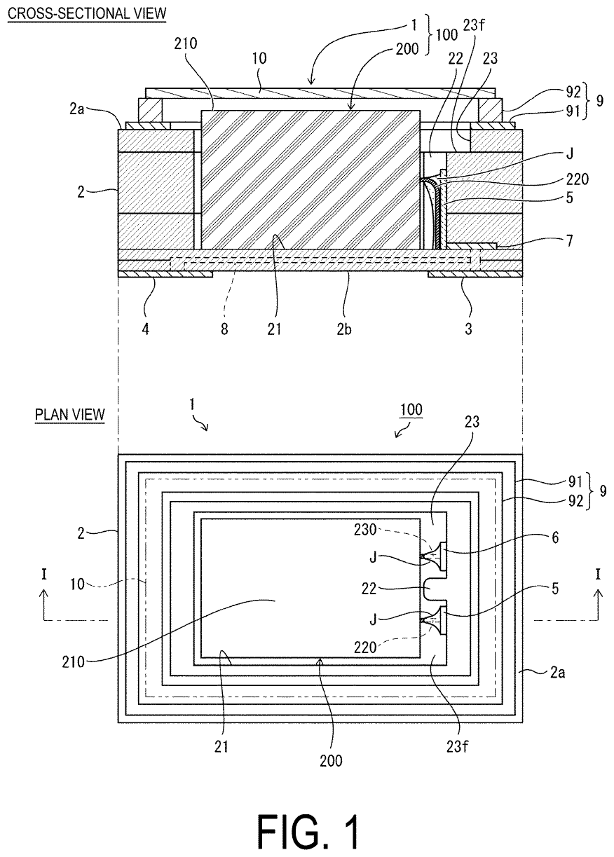

A battery package 1 and a battery module 100 according to the first embodiment will be described with reference to the cross-sectional view and the plan view of FIG. 1. The cross-sectional view of FIG. 1 is a schematic cross-sectional view taken along a line I-I in the plan view of FIG. 1, and the plan view of FIG. 1 is a schematic plan view illustrating the battery module 100 according to the first embodiment.

As in the example illustrated in the cross-sectional view and the plan view of FIG. 1, the battery module 100 according to the first embodiment includes the battery package 1 according to the first embodiment and a cylinder-type battery 200 mounted on the battery package 1. The battery package 1 includes an insulating substrate 2, and the shape of the insulating substrate 2 in a plan view may be, for example, a rectangular shape. The insulating substrate 2 is made of, for example, a ceramic such as an aluminum oxide sintered body (alumina ceramic), an aluminum nitride sintered body, a mullite sintered body, or a glass ceramic sintered body. The insulating substrate 2 is made of a plurality of laminated insulating layers or one insulating layer.

The insulating substrate 2 has a first surface 2a and a second surface 2b located on a side opposite to the first surface 2a. The insulating substrate 2 has a recessed portion 21 for accommodating the cylinder-type battery 200, and the recessed portion 21 is exposed in the first surface 2a. The recessed portion 21 of the insulating substrate 2 may have, for example, a rectangular shape in a plan view. An inner side surface of the recessed portion 21 of the insulating substrate 2 may be parallel to the thickness direction of the insulating substrate 2. The size of the recessed portion 21 of the insulating substrate 2 in a plan view may be slightly larger than the size of a battery body 210 of the battery 200 in a plan view. The depth of the recessed portion 21 may be substantially the same as the thickness of the battery body 210 of the battery 200. The shape of the recessed portion 21 of the insulating substrate 2 in a plan view is not limited to a rectangular shape, and can be changed according to the shape of the battery body 210 of the battery 200.

As in the example illustrated in the cross-sectional view of FIG. 1, the battery package 1 includes a first external electrode 3 located on the second surface 2b of the insulating substrate 2. The first external electrode 3 may be located on one end portion side of the second surface 1b of the insulating substrate 2. The first external electrode 3 may extend from the second surface 2b to the side surface (including corners between a plurality of side surfaces) of the insulating substrate 2. The first external electrode 3 may be electrically connectable to the first electrode of the mounting substrate via solder. The first external electrode 3 is made of metallization metal powder containing tungsten (W), molybdenum (Mo), manganese (Mn), silver (Ag), copper (Cu), or the like as a component.

The battery package 1 includes a second external electrode 4 located on the second surface 2b of the insulating substrate 2. The second external electrode 4 may be located on the other end portion side of the second surface 2b of the insulating substrate 2. The second external electrode 4 may extend from the second surface 2b to the side surface of the insulating substrate 2. The second external electrode 4 may be electrically connectable to a second electrode of the mounting substrate via solder. The second external electrode 4 is made of the same metallization metal powder as the first external electrode 3.

As in the example illustrated in the cross-sectional view and the plan view of FIG. 1, the battery package 1 includes a first electrode 5 located on the inner side surface of the recessed portion 21 of the insulating substrate 2, and the first electrode 5 is electrically connected to the first external electrode 3. The first electrode 5 may extend along the depth direction of the recessed portion 21 of the insulating substrate 2 (hereinafter, referred to as the depth direction of the recessed portion 21). The first electrode 5 may extend to the height position of the bottom surface of the recessed portion 21 of the insulating substrate 2. The shape of the first electrode 5 viewed from the inside of the recessed portion 21 of the insulating substrate 2 may be a rectangular shape. The first electrode 5 is made of the same metallization metal powder as the first external electrode 3 and the like.

The battery package 1 includes a second electrode 6 located on the inner side surface of the recessed portion 21 of the insulating substrate 2, and the second electrode 6 is electrically connected to the second external electrode 4. The second electrode 6 may extend along the depth direction of the recessed portion 21. The second electrode 6 may extend to the height position of the bottom surface of the recessed portion 21 of the insulating substrate 2. The shape of the second electrode 6 viewed from the inside of the recessed portion 21 of the insulating substrate 2 may be a rectangular shape. The first electrode 5 and the second electrode 6 may be arranged in the lateral direction. The second electrode 6 is made of the same metallization metal powder as the first external electrode 3 and the like.

As in the example illustrated in the cross-sectional view and the plan view of FIG. 1, the insulating substrate 2 may have a protrusion 22 located between the first electrode 5 and the second electrode 6 on the inner side surface of the recessed portion 21. In other words, the recessed portion 21 of the insulating substrate 2 may have the protrusion 22 located between the first electrode 5 and the second electrode 6 on the inner side surface thereof. The protrusion 22 of the insulating substrate 2 may extend along the depth direction of the recessed portion 21 from the opening side toward the bottom surface side of the recessed portion 21. The insulating substrate 2 may have a step portion 23 at an edge portion of the recessed portion 21. A step surface 23f of the step portion 23 of the insulating substrate 2 is located closer to the opening side of the recessed portion 21 than the first electrode 5 and the second electrode 6. The step portion 23 of the insulating substrate 2 may be located over the entire periphery of the edge portion of the recessed portion 21.

As in the example illustrated in the cross-sectional view of FIG. 1, the battery package 1 may include a first connection wiring line 7 that electrically connects the first electrode 5 and the first external electrode 3. The first connection wiring line 7 may include a through conductor penetrating one or a plurality of insulating layers and one or a plurality of wiring layers located between the insulating layers. The first connection wiring line 7 is made of the same metallization metal powder as the first external electrode 3 and the like.

The battery package 1 may include a second connection wiring line 8 that electrically connects the second electrode 6 and the second external electrode 4. The second connection wiring line 8 may include one or a plurality of through conductors penetrating one or a plurality of insulating layers and one or a plurality of wiring layers located between the insulating layers. The second connection wiring line 8 is made of the same metallization metal powder as the first external electrode 3 and the like.

As in the example illustrated in the cross-sectional view and the plan view of FIG. 1, when the insulating substrate 2 is made of, for example, an aluminum oxide sintered body, the insulating substrate 2 is produced as follows. An appropriate organic binder, a solvent, and the like are added to and mixed with a raw material powder of aluminum oxide, silicon oxide or the like to produce a slurry. A ceramic green sheet for an insulating layer is produced by forming the slurry into a sheet shape by a doctor blade method, a calender roll method, or the like. The ceramic green sheet for the insulating layer is subjected to appropriate punching for forming holes such as the recessed portion 21 having the protrusion 22 and the step portion 23. Then, a plurality of ceramic green sheets for the insulating layer are layered to produce a laminate for the insulating substrate 2. Thereafter, the laminate for the insulating substrate 2 is fired at a high temperature (about 1300 to 1600° C.), whereby the insulating substrate 2 is produced.

The battery package 1 may include a frame portion 9 surrounding the recessed portion 21 on the first surface 2a of the insulating substrate 2. The frame portion 9 may include a frame-shaped metal film 91 located surrounding the recessed portion 21 on the first surface 2a of the insulating substrate 2, and a metal frame body 92 bonded onto a frame-shaped metal film 91 with a brazing material. The frame-shaped metal film 91 is made of the same metallization metal powder as the first external electrode 3 and the like. As a constituent material of the metal frame body 92, a material having a small difference in thermal expansion from a ceramic may be used. For example, an iron-nickel (Fe—Ni) alloy or an iron-nickel-cobalt (Fe—Ni—Co) alloy may be used. In the battery package 1, the metal frame body 92 may be omitted from the configuration of the frame portion 9.

When the first external electrode 3, the second external electrode 4, the first electrode 5, the second electrode 6, the first connection wiring line 7, the second connection wiring line 8, and the frame-shaped metal film 91 are, for example, a metallized layer of tungsten, they can be formed as follows. The first external electrode 3, the second external electrode 4, the first electrode 5, the second electrode 6, the wiring layer of the first connection wiring line 7, the wiring layer of the second connection wiring line 8, and the frame-shaped metal film 91 are formed by printing a metal paste produced by mixing tungsten powder with an organic solvent and an organic binder on predetermined positions of ceramic green sheets for insulating layers by a method such as a screen printing method and firing a laminate for the insulating substrate 2. The through conductor of the first connection wiring line 7 and the through conductor of the second connection wiring line 8 are formed by providing a hole for the through conductor at a predetermined position of the ceramic green sheet for the insulating layer and filling the hole for the through conductor with a metal paste.

The surfaces of the first external electrode 3, the second external electrode 4, the first electrode 5, the second electrode 6, the first connection wiring line 7, and the second connection wiring line 8 exposed to the outside may be coated with a nickel plating layer/gold plating layer as a metal plating layer by a plating method such as an electrolytic plating method or an electroless plating method. Thus, corrosion of the first external electrode 3, the second external electrode 4, and the like can be effectively reduced. The metal plating layer is not limited to the nickel plating layer/gold plating layer, and may be another metal plating layer including a nickel plating layer/palladium plating layer/gold plating layer, or the like.

The battery package 1 may include a lid body 10 having a flat plate shape that closes the opening of the frame portion 9. The shape of the lid body 10 in a plan view may be, for example, a rectangular shape. The lid body 10 may have a shape other than a rectangular shape as long as the lid body 10 can close the opening of the frame portion 9. The lid body 10 is made of, for example, a ceramic or metal. As the constituent material of the lid body 10, a material having a small difference in thermal expansion from a ceramic, for example, an iron-nickel (Fe—Ni) alloy or an iron-nickel-cobalt (Fe—Ni—Co) alloy may be used.

The bonding between the lid body 10 and the frame portion 9 may be bonding using a bonding material such as a brazing material. The lid body 10 and the frame portion 9 may be bonded to each other using glass or a brazing material as a bonding material in order to increase the airtightness of the battery module 100. In the case where the lid body 10 made of a ceramic and the frame portion 9 are bonded to each other with a brazing material, a metal film having the same configuration as the frame-shaped metal film 91 may also be located on the outer edge portion of the lower surface of the lid body 10.

The lid body 10 made of metal and the metal frame body 92 of the frame portion 9 may be bonded to each other by welding such as seam welding, for example, in order to enhance the hermetic sealing property of the battery module 100. When the metal frame body 92 is omitted from the configuration of the frame portion 9, the lid body 10 made of metal and the frame-shaped metal film 91 may be bonded to each other by welding such as seam welding, direct seam welding, laser welding, or electron beam welding. The bonding using the seam welding, the direct seam welding, the laser welding, or the electron beam welding is bonding by local heating of the bonding portion, and thus the influence of heat on the battery 200 is smaller than in the case of using brazing which is bonding by overall heating (reflow heating).

When the battery package 1 is sealed, the hermetic sealing may be performed under a low dew point such as in a nitrogen atmosphere, an argon atmosphere, or a vacuum atmosphere. As a result, since the periphery of the cylinder-type battery 200 can be maintained in a low dew point environment, moisture and oxygen can be suppressed from entering from the outside of the battery package 1 and the likelihood of the battery material of the battery 200 deteriorating can be reduced. Before the battery package 1 is sealed, moisture in the battery package 1 may be evaporated by prebaking or the like.

As in the example illustrated in the cross-sectional view and the plan view of FIG. 1, the battery module 100 includes the battery package 1 and the cylinder-type battery 200 accommodated in the recessed portion 21 of the insulating substrate 2 in the battery package 1. The cylinder-type battery 200 may be bonded to the bottom surface of the recessed portion 21 of the insulating substrate 2 with a bonding material such as a resin adhesive. The cylinder-type battery 200 includes the battery body 210, and a first lead terminal 220 having a linear shape and a second lead terminal 230 having a linear shape which protrude from one side of the battery body 210. The battery body 210 may have a rectangular shape in a plan view. There may be a gap between the battery body 210 and the inner side surface of the recessed portion 21 of the insulating substrate 2.

The first lead terminal 220 may be electrically connected to the first electrode 5 in a state of being bent downward (toward the bottom surface of the recessed portion 21 of the insulating substrate 2). The second lead terminal 230 may be electrically connected to the second electrode 6 in a state of being bent downward. The first lead terminal 220 and the second lead terminal 230 may be bent so as to be in pressure contact with the first electrode 5 and the second electrode 6, respectively, by elastic force. The first lead terminal 220 may be bonded to the first electrode 5 with a conductive bonding material J such as solder or a conductive resin. The second lead terminal 230 may be bonded to the second electrode 6 with the conductive bonding material J.

A portion of the first lead terminal 220 and a portion of the second lead terminal 230 may be bent in an arch shape so that the first lead terminal 220 and the second lead terminal 230 can effectively exert an elastic force. A portion of the first lead terminal 220 and the second lead terminal 230 may be bent into a coil shape. As long as each of the first lead terminal 220 and the second lead terminal 230 can effectively exert an elastic force, the first electrode 5 and the second electrode 6 may be bent into an appropriate shape.

As in the example illustrated in the cross-sectional view and the plan view of FIG. 1, in the battery package 1 according to the first embodiment, the first electrode 5 and the second electrode 6 are located on the inner side surface of the recessed portion 21 of the insulating substrate 2. Therefore, when the cylinder-type battery 200 is accommodated in the recessed portion 21 of the insulating substrate 2 in a state where the first lead terminal 220 and the second lead terminal 230 are bent, the first lead terminal 220 and the second lead terminal 230 are electrically connected to the first electrode 5 and the second electrode 6, respectively. Accordingly, the cylinder-type battery 200 can be mounted on the battery package 1 without adjusting the height of the bonding portion (connection portion) between the first lead terminal 220 and the first electrode 5 and the height of the bonding portion between the second lead terminal 230 and the second electrode 6. Therefore, according to the example of the first embodiment, the assemblability of the battery module 100 including the battery package 1 and the battery 200 can be improved.

As described above, the cylinder-type battery 200 is accommodated in the recessed portion 21 of the insulating substrate 2 in a state where the first lead terminal 220 and the second lead terminal 230 are bent. Therefore, the size of the recessed portion 21 of the insulating substrate 2 in a plan view can be reduced by an amount corresponding to the bending of the first lead terminal 220 and the second lead terminal 230. Thus, according to the example of the first embodiment, the size of the battery package 1 can be reduced, in other words, the size of the battery module 100 can be reduced.

When the first electrode 5 and the second electrode 6 are arranged in the lateral direction, the conductive bonding material J for bonding the first lead terminal 220 to the first electrode 5 (hereinafter, referred to as the conductive bonding material J for the first lead terminal 220) is less likely to drip onto the second electrode 6. The conductive bonding material J for bonding the second lead terminal 230 to the second electrode 6 (hereinafter, referred to as the conductive bonding material J for the second lead terminal 230) does not easily drip onto the first electrode 5. As a result, according to the example of the first embodiment, the likelihood of a short circuit between the first electrode 5 and the second electrode 6 due to dripping of the conductive bonding material J can be reduced (operational effect related to avoidance of a short circuit due to dripping of the conductive bonding material J).

When the protrusion 22 is located between the first electrode 5 and the second electrode 6 on the inner side surface of the recessed portion 21 of the insulating substrate 2, the conductive bonding material J for the first lead terminal 220 and the conductive bonding material J for the second lead terminal 230 are less likely to come into contact with each other. Thus, according to the example of the first embodiment, the likelihood of a short circuit between the first electrode 5 and the second electrode 6 can be reduced (the operational effect related to the protrusion 22).

When the first electrode 5 and the second electrode 6 arranged in the lateral direction extend to the height position of the bottom surface of the recessed portion 21 of the insulating substrate 2, the bonding area between the first lead terminal 220 and the first electrode 5 (the bonding area between the conductive bonding material J and the first electrode 5) and the bonding area between the second lead terminal 230 and the second electrode 6 (the bonding area between the conductive bonding material J and the second electrode 6) can be increased. Thus, the bonding strength (bonding force) of the first lead terminal 220 to the first electrode 5 and the bonding strength of the second lead terminal 230 to the second electrode 6 can be increased. Therefore, according to the example of the first embodiment, the connection reliability of the battery module 100 can be improved.

When the battery package 1 is provided with the lid body 10, the battery package 1 can be hermetically sealed to reduce the likelihood of entry of moisture or the like into the battery package 1. In particular, when the insulating substrate 2 is made of a ceramic, the battery package 1 can be hermetically sealed, and the likelihood of entry of moisture or the like into the battery package 1 can be further reduced. As a result, according to the example of the first embodiment, deterioration of the cylinder-type battery 200 mounted on the battery package 1 can be suppressed and the long-term durability (life) of the battery module 100 (operation related to hermetic sealing) can be improved.

When the insulating substrate 2 has the step portion 23, the conductive bonding material J for the first lead terminal 220 and the conductive bonding material J for the second lead terminal 230 are less likely to come into contact with the frame portion 9. Thus, according to the example of the first embodiment, the likelihood of a short circuit between the first electrode 5 and the frame portion 9 and the likelihood of a short circuit between the second electrode 6 and the frame portion 9 can be reduced (the operational effect related to the step portion 23).

### Another Aspect of First Embodiment

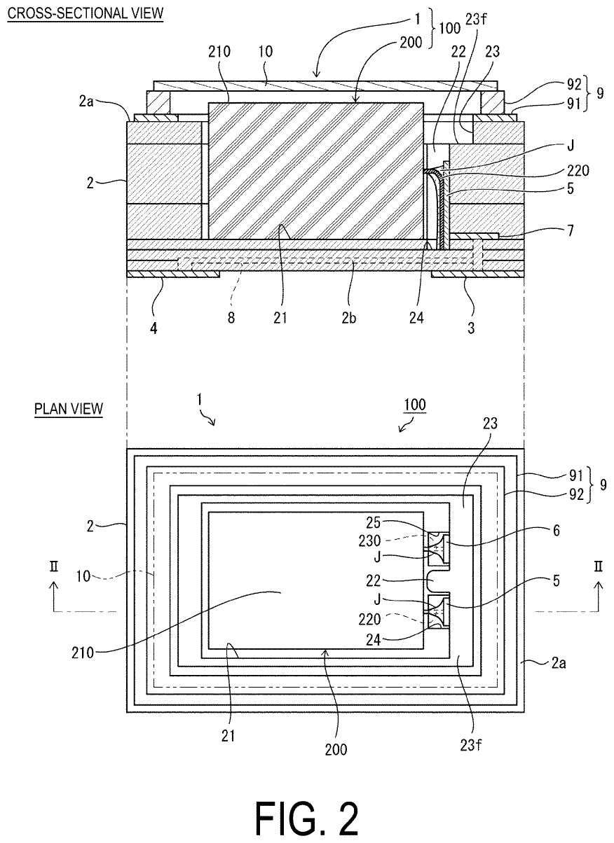

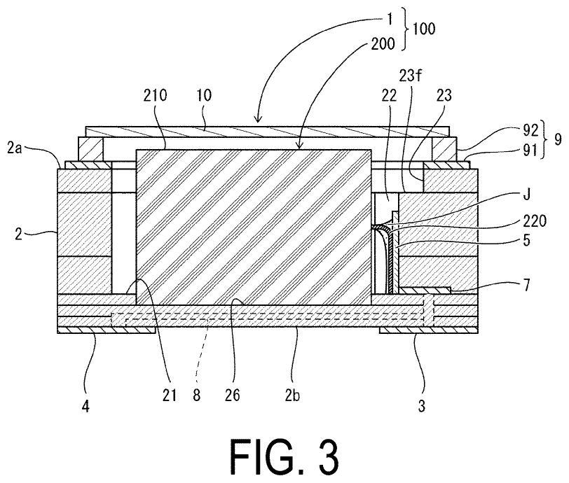

Another aspect of the battery package 1 and the battery module 100 according to the first embodiment will be described with reference to FIGS. 2 to 5. The cross-sectional view of FIG. 2 is a schematic cross-sectional view taken along a line II-II in the plan view of FIG. 2. The plan view of FIG. 2 is a schematic plan view illustrating the battery module 100 according to another aspect of the first embodiment. FIGS. 3 to 5 are schematic cross-sectional views illustrating the battery module 100 according to other aspects of the first embodiment.

As in the example illustrated in the cross-sectional view and the plan view of FIG. 2, the insulating substrate 2 may have depressions 24, 25 and located at positions corresponding to the first electrode 5 and the second electrode 6, respectively, on the bottom surface of the recessed portion 21. The depression 24 of the insulating substrate 2 may dam the conductive bonding material J for the first lead terminal 220. The depression 25 of the insulating substrate 2 may dam the conductive bonding material J for the second lead terminal 230. The first electrode 5 may extend to the inner side surface of the depression 24 continuous with the inner side surface of the recessed portion 21 of the insulating substrate 2. The first electrode 5 may extend to the bottom surface of the depression 24 of the insulating substrate 2. The second electrode 6 may extend to the inner side surface of the depression 25 continuous with the inner side surface of the recessed portion 21 of the insulating substrate 2. The second electrode 6 may extend to the bottom surface of the depression 25 of the insulating substrate 2. The depressions 24, 25 of the insulating substrate 2 are formed by appropriately punching a ceramic green sheet for an insulating layer.

As in the example illustrated in the cross-sectional view and the plan view of FIG. 2, when the insulating substrate 2 has the depressions 24, 25, the conductive bonding material J for the first lead terminal 220 and the conductive bonding material J for the second lead terminal 230 are less likely to come into contact with each other on the bottom surface of the recessed portion 21 of the insulating substrate 2. Therefore, according to the example of another aspect of the first embodiment, the likelihood of a short circuit between the first electrode 5 and the second electrode 6 due to the conductive bonding material J which spreads on the bottom surface of the recessed portion 21 of the insulating substrate 2 can be reduced.

When each of the first electrode 5 and the second electrode 6 extends to the inner side surface or the bottom surface of the depressions 24, 25 of the insulating substrate 2, the bonding area between the first lead terminal 220 and the first electrode 5 and the bonding area between the second lead terminal 230 and the second electrode 6 can be increased. Thus, the bonding strength of the first lead terminal 220 to the first electrode 5 and the bonding strength of the second lead terminal 230 to the second electrode 6 can be increased. Therefore, according to the example of another aspect of the first embodiment, the connection reliability of the battery module 100 can be further improved.

As in the example illustrated in FIG. 3, the insulating substrate 2 may have a second recessed portion 26 exposed to the bottom surface of the recessed portion 21. The second recessed portion 26 of the insulating substrate 2 is a recessed portion which can be engaged with a lower portion which is a part of the battery body 210 of the cylinder-type battery 200. The shape of the second recessed portion 26 of the insulating substrate 2 in a plan view may be, for example, a rectangular shape. The inner side surface of the second recessed portion 26 of the insulating substrate 2 may be parallel to the thickness direction of the insulating substrate 2. The size of the second recessed portion 26 of the insulating substrate 2 in a plan view corresponds to the size of the battery body 210 of the battery 200. The shape of the second recessed portion 26 of the insulating substrate 2 in a plan view is not limited to a rectangular shape, and can be changed in accordance with the shape of the battery body 210 of the battery 200.

The cylinder-type battery 200 in the battery module 100 is accommodated in the recessed portion 21 of the insulating substrate 2 in a state where the lower portion of the battery body 210 is engaged with the second recessed portion 26 of the insulating substrate 2. The cylinder-type battery 200 may be bonded to the bottom surface of the second recessed portion 26 of the insulating substrate 2 with a bonding material such as a resin adhesive.

As in the example illustrated in FIG. 3, when the insulating substrate 2 has the second recessed portion 26, the cylinder-type battery 200 can be easily positioned with respect to the insulating substrate 2 by engaging the lower portion of the battery body 210 with the second recessed portion 26 of the insulating substrate 2. Thus, according to the example of another aspect of the first embodiment, the assemblability of the battery module 100 can be further improved.

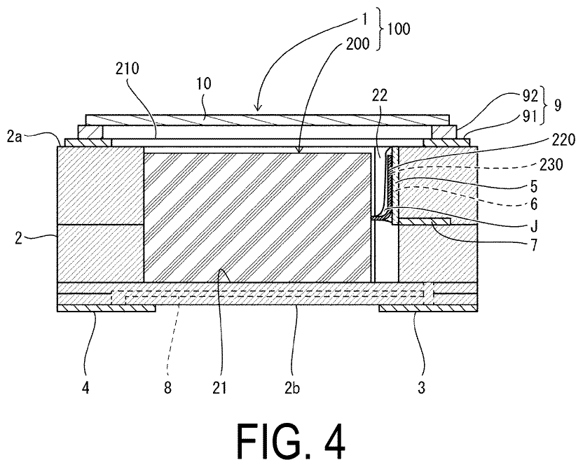

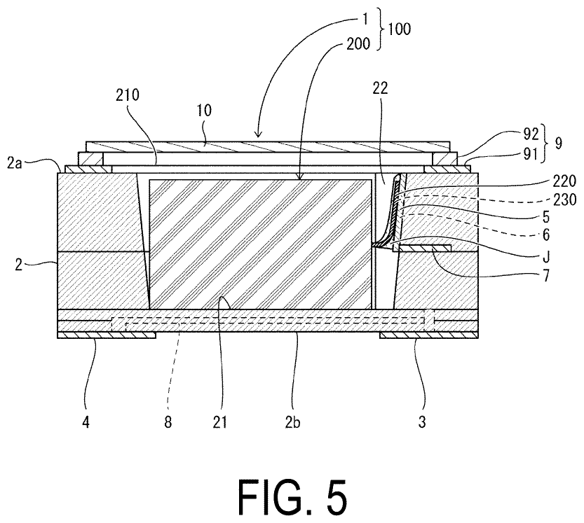

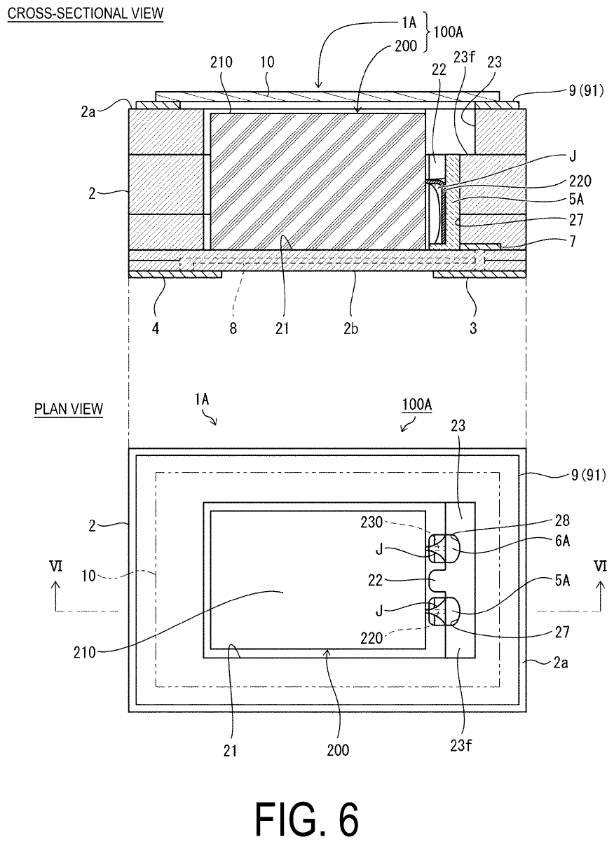

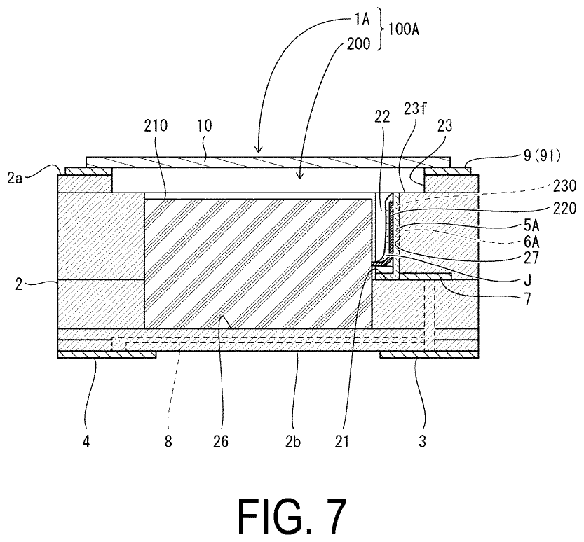

As in the example illustrated in FIGS. 4 and 5, the first electrode 5 may extend from the central portion in the depth direction of the recessed portion 21 of the insulating substrate 2 to the opening side of the recessed portion 21. The second electrode 6 may extend from the central portion in the depth direction of the recessed portion 21 of the insulating substrate 2 to the opening side of the recessed portion 21. In the example illustrated in FIGS. 6 and 7, the second electrode 6 is illustrated to overlap the first electrode 5.

As in the example illustrated in FIGS. 4 and 5, in the battery module 100, the first lead terminal 220 may be electrically connected to the first electrode 5 in a state of being bent upward (toward the opening side of the recessed portion 21 of the insulating substrate 2). The second lead terminal 230 may be electrically connected to the second electrode 6 in a state of being bent upward. The first lead terminal 220 may be bonded to the first electrode 5 with the conductive bonding material J. The second lead terminal 230 may be bonded to the second electrode 6 with the conductive bonding material J. The first lead terminal 220 may be mechanically bonded to the first electrode 5 without using the conductive bonding material J. The second lead terminal 230 may be mechanically bonded to the second electrode 6 without using the conductive bonding material J.

As in the example illustrated in FIG. 5, among the plurality of inner side surfaces of the recessed portion 21 of the insulating substrate 2, the inner side surface of the recessed portion 21 where the first electrode 5 and the second electrode 6 are located (referred to as the electrode-side inner side surface of the recessed portion 21) may be inclined outward with respect to the depth direction of the recessed portion 21. The inner side surface of the recessed portion 21 facing the inner side surface on the electrode side may be inclined outward with respect to the depth direction of the recessed portion 21.

As in the example illustrated in FIGS. 4 and 5, when the first electrode 5 and the second electrode 6 extend from the central portion in the depth direction of the recessed portion 21 of the insulating substrate 2 to the opening side of the recessed portion 21, the battery 200 can be inserted (accommodated) into the recessed portion 21 of the insulating substrate 2 in a state where the first lead terminal 220 and the second lead terminal 230 are bent upward. Thus, the insertion resistance of the first lead terminal 220 or the second lead terminal 230 of the battery 200 into the recessed portion 21 of the insulating substrate 2 can be reduced. Therefore, according to the example of another aspect of the first embodiment, the assemblability of the battery module 100 including the battery package 1 and the battery 200 can be further improved.

As in the example illustrated in FIG. 5, in the case where the inner side surface of the recessed portion 21 on the electrode side is inclined outward with respect to the depth direction of the recessed portion 21, the first electrode 5 and the second electrode 6 are inclined outward with respect to the depth direction of the recessed portion 21. Therefore, in the battery 200, the insertion resistance of the first lead terminal 220 or the second lead terminal 230 with respect to the recessed portion 21 of the insulating substrate 2 can be further reduced. Therefore, according to the example of another aspect of the first embodiment, the assemblability of the battery module 100 can be further improved.

### Second Embodiment

A battery package 1A and a battery module 100A according to the second embodiment will be described with reference to the cross-sectional view and the plan view of FIG. 6. The cross-sectional view of FIG. 6 is a schematic cross-sectional view taken along a line VI-VI in the plan view of FIG. 6. The plan view of FIG. 6 is a schematic plan view illustrating the battery module 100A according to the second embodiment.

As in the example illustrated in the cross-sectional view and the plan view of FIG. 6, the battery module 1A according to the second embodiment includes the battery package 1A according to the second embodiment and a cylinder-type battery 200 mounted on the battery package 1A. The battery package 1A according to the second embodiment has the same configuration as the battery package 1 according to the first embodiment except for a part of the configuration. Among the configurations of the battery package 1A according to the second embodiment, configurations different from those of the battery package 1 according to the first embodiment will be described. For convenience of description, a member having the same function as that of a member described in the first embodiment is denoted by the same reference sign.

The battery package 1A includes a first electrode 5A located on the inner side surface of the recessed portion 21 of the insulating substrate 2, and the first electrode 5A corresponds to the first electrode 5 of the battery package 1. The first electrode 5A may be made of a metal body filled in a groove 27 that is elongated and open on the inner side surface of the recessed portion 21 of the insulating substrate 2. The first electrode 5A may extend to the upper end (end portion on the step portion 23 side) of the groove 27 of the insulating substrate 2. The groove 27 of the insulating substrate 2 may extend along the depth direction of the recessed portion 21. The groove 27 of the insulating substrate 2 may extend to the opening side of the recessed portion 21. The first electrode 5A may extend along the depth direction of the recessed portion 21. The first electrode 5A may extend to the height position of the bottom surface of the recessed portion 21 of the insulating substrate 2. The first electrode 5A is made of the same metallization metal powder as the first external electrode 3 and the like. The shape of the groove 27 of the insulating substrate 2 is not limited to the elongated shape.

The battery package 1A includes a second electrode 6A located on the inner side surface of the recessed portion 21 of the insulating substrate 2, and the second electrode 6A corresponds to the second electrode 6 of the battery package 1. The second electrode 6A may be made of a metal material filled in a groove 28 that is elongated and open on the inner side surface of the recessed portion 21 of the insulating substrate 2. The groove 28 of the insulating substrate 2 may extend along the depth direction of the recessed portion 21. The groove 28 of the insulating substrate 2 may extend to the opening side of the recessed portion 21. The second electrode 6A may extend along the depth direction of the recessed portion 21. The second electrode 6A may extend to the upper end of the groove 28 of the insulating substrate 2. The second electrode 6A may extend to the height position of the bottom surface of the recessed portion 21 of the insulating substrate 2. The first electrode 5A and the second electrode 6A may be arranged in the lateral direction. The second electrode 6A is made of the same metallization metal powder as the first external electrode 3 and the like. The shape of the groove 28 of the insulating substrate 2 is not limited to an elongated shape.

The grooves 27, 28 of the insulating substrate 2 are formed by appropriately punching a ceramic green sheet for an insulating layer. In the case where the first electrode 5A and the second electrode 6A are made of, for example, tungsten metallization metal powders, the first electrode 5A and the second electrode 6A are each formed by filling a hole corresponding to the grooves 27, 28 formed at a predetermined position of a ceramic green sheet for an insulating layer with a metal paste and punching out a portion of the hole. The surfaces of the first electrode 5A and the second electrode 6A exposed to the outside may be coated with a metal-plated layer such as a nickel-plated layer or a gold-plated layer by a plating method such as an electrolytic plating method or an electroless plating method.

As in the example illustrated in the cross-sectional view and the plan view of FIG. 6, each of the first electrode 5A and the second electrode 6A may extend to the bottom surface of the recessed portion 21 of the insulating substrate 2. The portions of the first electrode 5A and the second electrode 6A extending along the bottom surface of the recessed portion 21 of the insulating substrate 2 are formed by being printed at predetermined positions of the ceramic green sheet for the insulating layer by a method such as a screen printing method in the same manner as the first connection wiring line 7. The portion of the first connection wiring line 7 extending to the bottom surface of the recessed portion 21 may be a portion extending along the bottom surface of the first electrode 5A.

The protrusion 22 of the insulating substrate 2 may be located between the first electrode 5A and the second electrode 6A on the inner side surface of the recessed portion 21. The step portion 23 of the insulating substrate 2 may be located closer to the opening side of the recessed portion 21 than the first electrode 5A and the second electrode 6A at the edge of the recessed portion 21.

As in the example illustrated in the cross-sectional view and the plan view of FIG. 6, the lid body 10 made of metal may be bonded to the frame-shaped metal film 91 by welding such as seam welding, direct seam welding, laser welding, or electron beam welding. The bonding using the seam welding, the direct seam welding, the laser welding, or the electron beam welding is bonding by local heating of the bonding portion, and thus the influence of heat on the battery 200 is smaller than in the case of using brazing which is bonding by overall heating (reflow heating).

As in the example illustrated in the cross-sectional view and the plan view of FIG. 6, in the battery module 100A, the first lead terminal 220 may be electrically connected to the first electrode 5A in a state of being bent downward. The second lead terminal 230 may be electrically connected to the second electrode 6A in a state of being bent downward. The first lead terminal 220 may be bonded to the first electrode 5A with the conductive bonding material J. The second lead terminal 230 may be bonded to the second electrode 6A with the conductive bonding material J.

The technique applied to the battery package 1 according to another aspect of the first embodiment of the example illustrated in FIG. 3 may be applied to the battery package 1A.

As in the example illustrated in the cross-sectional view and the plan view of FIG. 6, in the battery package 1A according to the second embodiment, the first electrode 5A and the second electrode 6A are located on the inner side surfaces of the recessed portion 21 of the insulating substrate 2. Therefore, when the cylinder-type battery 200 is accommodated in the recessed portion 21 of the insulating substrate 2 in a state where the first lead terminal 220 and the second lead terminal 230 are bent, the first lead terminal 220 and the second lead terminal 230 are electrically connected to the first electrode 5A and the second electrode 6A, respectively. Accordingly, the cylinder-type battery 200 can be mounted on the battery package 1A without adjusting the height of the bonding portion between the first lead terminal 220 and the first electrode 5A and the height of the bonding portion between the second lead terminal 230 and the second electrode 6A. Therefore, according to the example of the second embodiment, the assemblability of the battery module 100A including the battery package 1A and the battery 200 can be improved.

As described above, the cylinder-type battery 200 is accommodated in the recessed portion 21 of the insulating substrate 2 in a state where the first lead terminal 220 and the second lead terminal 230 are bent. Therefore, the size of the recessed portion 21 of the insulating substrate 2 in a plan view can be reduced by an amount corresponding to the bending of the first lead terminal 220 and the second lead terminal 230. Thus, according to the example of the second embodiment, the size of the battery package 1 can be reduced, in other words, the size of the battery module 100A can be reduced.

When the first electrode 5A and the second electrode 6A arranged in the lateral direction extend to the height position of the bottom surface of the recessed portion 21 of the insulating substrate 2, the bonding area between the first lead terminal 220 and the first electrode 5A (the bonding area between the conductive bonding material J and the first electrode 5A) and the bonding area between the second lead terminal 230 and the second electrode 6A (the bonding area between the conductive bonding material J and the second electrode 6A) can be increased. Thus, the bonding strength of the first lead terminal 220 to the first electrode 5A and the bonding strength of the second lead terminal 230 to the second electrode 6A can be increased. Therefore, according to the example of the second embodiment, the connection reliability of the battery module 100A can be improved.

In the case where the first electrode 5A and the second electrode 6A extend on the bottom surface of the recessed portion 21 of the insulating substrate 2, the bonding area between the first lead terminal 220 and the first electrode 5A and the bonding area between the second lead terminal 230 and the second electrode 6A can be further increased. The bonding interfaces between the conductive bonding material J and the first electrode 5A and the second electrode 6A are multifaceted (curved surfaces). Thus, the bonding strength of the first lead terminal 220 to the first electrode 5A and the bonding strength of the second lead terminal 230 to the second electrode 6A can be increased. Therefore, according to the example of the second embodiment, the connection reliability of the battery module 100A can be improved.

When the first electrode 5A and the second electrode 6A are metal bodies filled in the grooves 27, 28 of the insulating substrate 2, the bonding area between the first electrode 5A and the insulating substrate 2 and the bonding area between the second electrode 6A and the insulating substrate 2 can be increased. Thus, the bonding strength of the first electrode 5A to the insulating substrate 2 and the bonding strength of the second electrode 6A to the insulating substrate 2 can be increased. Therefore, according to the example of the second embodiment, the long-term reliability of the battery module can be improved.

In addition, also in the example of the second embodiment, the above-described operational effect related to avoidance of a short circuit due to dripping of the conductive bonding material J, the operational effect related to hermetic sealing, the operational effect related to the protrusion 22, and the operational effect related to the step portion 23 are achieved.

### Another Aspect of Second Embodiment

Another aspect of the battery package 1A and the battery module 100A according to the second embodiment will be described with reference to FIG. 7. FIG. 7 is a schematic cross-sectional view illustrating the battery module 100A according to another aspect of the second embodiment.

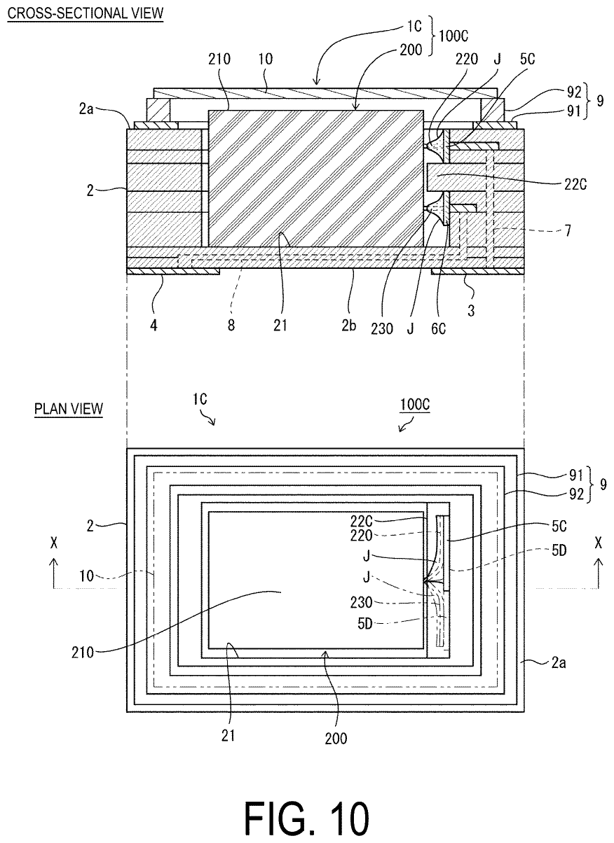

As in the example illustrated in FIG. 7, the first electrode 5A may extend from the central portion in the depth direction of the recessed portion 21 of the insulating substrate 2 to the opening side of the recessed portion 21. The second electrode 6A may extend from the central portion in the depth direction of the recessed portion 21 of the insulating substrate 2 to the opening side of the recessed portion 21. In the example illustrated in FIG. 10, the second electrode 6A is illustrated overlapping the first electrode 5B.

As in the example illustrated in FIG. 7, the insulating substrate 2 may have the second recessed portion 26 exposed to the bottom surface of the recessed portion 21. The second recessed portion 26 of the insulating substrate 2 is a recessed portion which can be engaged with a lower portion which is a part of the battery body 210 of the cylinder-type battery 200. The shape of the second recessed portion 26 of the insulating substrate 2 in a plan view may be, for example, a rectangular shape. The inner side surface of the second recessed portion 26 of the insulating substrate 2 may be parallel to the thickness direction of the insulating substrate 2. The size of the second recessed portion 26 of the insulating substrate 2 in a plan view corresponds to the size of the battery body 210 of the battery 200. The shape of the second recessed portion 26 of the insulating substrate 2 in a plan view is not limited to a rectangular shape, and can be changed in accordance with the shape of the battery body 210 of the battery 200.

As in the example illustrated in FIG. 7, in the battery module 100A, the first lead terminal 220 may be electrically connected to the first electrode 5A in a state of being bent upward. The second lead terminal 230 may be electrically connected to the second electrode 6A in a state of being bent upward. The first lead terminal 220 may be bonded to the first electrode 5A with the conductive bonding material J. The second lead terminal 230 may be bonded to the second electrode 6A with the conductive bonding material J. The first lead terminal 220 may be mechanically bonded to the first electrode 5A without using the conductive bonding material J. The second lead terminal 230 may be mechanically bonded to the second electrode 6A without using the conductive bonding material J.

As in the example illustrated in FIG. 7, when the first electrode 5A and the second electrode 6A extend from the central portion in the depth direction of the recessed portion 21 of the insulating substrate 2 to the opening side of the recessed portion 21, the battery 200 can be inserted (accommodated) into the recessed portion 21 of the insulating substrate 2 in a state where the first lead terminal 220 and the second lead terminal 230 are bent upward. Thus, the insertion resistance of the first lead terminal 220 or the second lead terminal 230 of the battery 200 into the recessed portion 21 of the insulating substrate 2 can be reduced. Therefore, according to the example of another aspect of the second embodiment, the assemblability of the battery module 100A including the battery package 1A and the battery 200 can be further improved.

### Third Embodiment

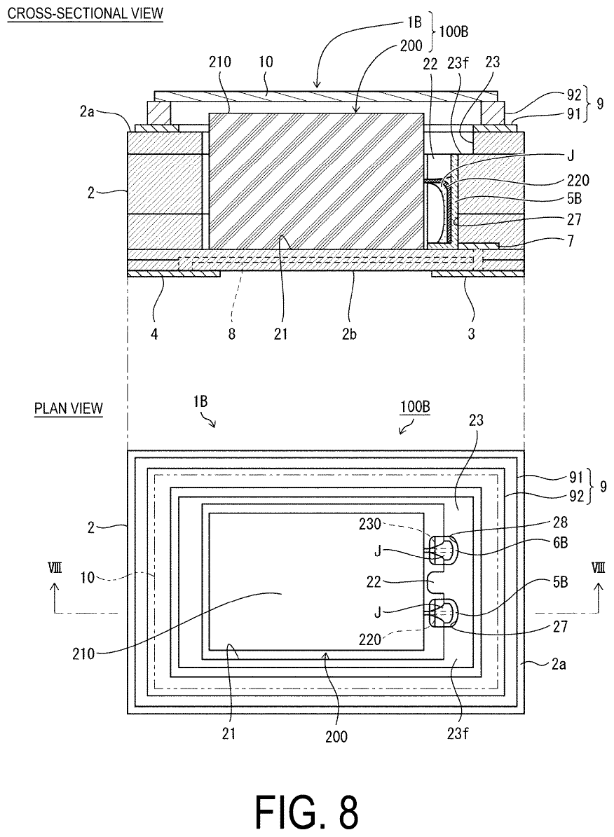

A battery package 1B and the battery module 100B according to the third embodiment will be described with reference to the cross-sectional view and the plan view of FIG. 8. The cross-sectional view of FIG. 8 is a schematic cross-sectional view taken along a line VIII-VIII in the plan view of FIG. 8. The plan view of FIG. 8 is a schematic plan view illustrating the battery module 100B according to the third embodiment.

As in the example illustrated in the cross-sectional view and the plan view of FIG. 8, the battery package 1B according to the third embodiment includes the battery package 1B according to the third embodiment and the cylinder-type battery 200 mounted on the battery package 1B. The battery package 1B according to the third embodiment has the same configuration as the battery package 1 according to the first embodiment except for a part of the configuration. Among the configurations of the battery package 1B according to the third embodiment, configurations different from those of the battery package 1 according to the first embodiment will be described. For convenience of description, a member having the same function as that of a member described in the first embodiment is denoted by the same reference sign.

The battery package 1B includes a first electrode 5B located on the inner side surface of the recessed portion 21 of the insulating substrate 2, and the first electrode 5B corresponds to the first electrode 5 of the battery package 1. The first electrode 5B may be a metal film (metal layer) located along the inner surface of the groove 27 that is elongated and exposed to the inner side surface of the recessed portion 21 of the insulating substrate 2. The first electrode 5B may extend along the depth direction of the recessed portion 21. The first electrode 5B may extend to the upper end of the groove 27 of the insulating substrate 2. The first electrode 5B may extend to the height position of the bottom surface of the recessed portion 21 of the insulating substrate 2. The first electrode 5B may extend to the bottom surface of the recessed portion 21 of the insulating substrate 2. The first electrode 5B is made of the same metallization metal powder as the first external electrode 3 and the like. The shape of the groove 27 of the insulating substrate 2 is not limited to an elongated shape.

The battery package 1B includes a second electrode 6B located on the inner side surface of the recessed portion 21 of the insulating substrate 2, and the second electrode 6B corresponds to the second electrode 6 of the battery package 1. The second electrode 6B may be a metal film (a metal layer) along the inner surface of the groove 28 that is elongated and exposed to the inner side surface of the recessed portion 21 of the insulating substrate 2. The second electrode 6B may extend along the depth direction of the recessed portion 21. The second electrode 6B may extend to the upper end of the groove 28 of the insulating substrate 2. The second electrode 6B may extend to the height position of the bottom surface of the recessed portion 21 of the insulating substrate 2. The first electrode 5B and the second electrode 6B may be arranged in the lateral direction. The second electrode 6B is made of the same metallization metal powder as the first external electrode 3 and the like. The shape of the groove 28 of the insulating substrate 2 is not limited to the elongated shape.

The first electrode 5B and the second electrode 6B are formed on the inner surfaces of the grooves 27, 28 of the insulating substrate 2 by, for example, hole printing. The method of forming the first electrode 5B and the second electrode 6B is not limited to hole printing, and may be, for example, coating, vapor deposition, or another method. The surfaces of the first electrode 5B and the second electrode 6B exposed to the outside may be coated with a metal-plated layer such as a nickel-plated layer or a gold-plated layer by a plating method such as an electrolytic plating method or an electroless plating method.

As in the example illustrated in the cross-sectional view of FIG. 8, each of the first electrode 5B and the second electrode 6B may extend to the bottom surface of the recessed portion 21 of the insulating substrate 2. The portions of the first electrode 5B and the second electrode 6B extending to the bottom surface of the recessed portion 21 of the insulating substrate 2 are formed by being printed at predetermined positions of the ceramic green sheet for the insulating layer by a method such as a screen-printing method in the same manner as the first electrode 5. The wiring layer of the first connection wiring line 7 may extend from the first electrode 5B side to the bottom surface of the recessed portion 21 of the insulating substrate 2. The wiring layer of the second connection wiring line 8 may extend from the second electrode 6B side to the bottom surface of the recessed portion 21 of the insulating substrate 2.

The protrusion 22 of the insulating substrate 2 may be located between the first electrode 5B and the second electrode 6B on the inner side surface of the recessed portion 21. The step portion 23 of the insulating substrate 2 may be located closer to the opening side of the recessed portion 21 than the first electrode 5B and the second electrode 6B at the edge of the recessed portion 21. In the battery package 1B, the protrusion 22 may be omitted from the configuration of the insulating substrate 2.

As in the example illustrated in the cross-sectional view and the plan view of FIG. 8, in the battery module 100B, the first lead terminal 220 may be electrically connected to the first electrode 5B in a state of being bent downward and inserted into the groove 27 of the insulating substrate 2. The second lead terminal 230 may be bent downward and inserted into the groove 28 of the insulating substrate 2 to be electrically connected to the second electrode 6B. The first lead terminal 220 may be bonded to the first electrode 5B with the conductive bonding material J. The second lead terminal 230 may be bonded to the second electrode 6B with the conductive bonding material J.

The technique applied to the battery package 1 according to another aspect of the first embodiment of the example illustrated in FIG. 3 may be applied to the battery package 1B.

As in the example illustrated in the cross-sectional view and the plan view of FIG. 8, in the battery package 1B according to the third embodiment, the first electrode 5B and the second electrode 6B are located on the inner side surfaces of the recessed portion 21 of the insulating substrate 2. Therefore, when the cylinder-type battery 200 is accommodated in the recessed portion 21 of the insulating substrate 2 in a state where the first lead terminal 220 and the second lead terminal 230 are bent, the first lead terminal 220 and the second lead terminal 230 are electrically connected to the first electrode 5B and the second electrode 6B, respectively. Accordingly, the cylinder-type battery 200 can be mounted on the battery package 1B without adjusting the height of the bonding portion between the first lead terminal 220 and the first electrode 5B and the height of the bonding portion between the second lead terminal 230 and the second electrode 6B. Therefore, according to the example of the third embodiment, the assemblability of the battery module 100B including the battery package 1B and the battery 200 can be improved.

In particular, when the first lead terminal 220 and the second lead terminal 230 are respectively inserted into the grooves 27, 28 of the insulating substrate 2, the first lead terminal 220 and the second lead terminal 230 can be easily positioned with respect to the insulating substrate 2. When the grooves 27, 28 of the insulating substrate 2 extend to the opening side of the recessed portion 21, the first lead terminal 220 and the second lead terminal 230 can be easily inserted into the grooves 27, 28 of the insulating substrate 2. Therefore, according to the example of the third embodiment, the assemblability of the battery module 100B can be further improved.

As described above, the cylinder-type battery 200 is accommodated in the recessed portion 21 of the insulating substrate 2 in a state where the first lead terminal 220 and the second lead terminal 230 are bent. Therefore, the size of the recessed portion 21 of the insulating substrate 2 in a plan view can be reduced by an amount corresponding to the bending of the first lead terminal 220 and the second lead terminal 230. In the case where the first lead terminal 220 and the second lead terminal 230 are respectively inserted into the inside of the grooves 27, 28 of the insulating substrate 2, the size of the recessed portion 21 of the insulating substrate 2 in a plan view can be further reduced by the amount of insertion of the first lead terminal 220 and the second lead terminal 230. Thus, according to the example of the third embodiment, the size of the battery package 1B can be reduced, in other words, the size of the battery module 100B can be reduced.

When the first lead terminal 220 and the second lead terminal 230 are inserted into the grooves 27, 28 of the insulating substrate 2, respectively, the first lead terminal 220 and the second lead terminal 230 are less likely to come into contact with each other. Thus, according to the example of the third embodiment, the likelihood of a short circuit between the first electrode 5B and the second electrode 6B can be reduced.

When the first lead terminal 220 is bonded to the first electrode 5B with the conductive bonding material J in a state where the first lead terminal 220 is inserted into the groove 27 of the insulating substrate 2, the bonding strength of the first lead terminal 220 to the first electrode 5B can be increased. When the second lead terminal 230 is bonded to the second electrode 6B with the conductive bonding material J in a state where the second lead terminal 230 is inserted into the groove 28 of the insulating substrate 2, the bonding strength of the second lead terminal 230 to the second electrode 6B can be increased. Therefore, according to the example of the third embodiment, the connection reliability of the battery module 100B can be improved.

Especially, when the first electrode 5B and the second electrode 6B arranged in the lateral direction extend to the height position of the bottom surface of the recessed portion 21 of the insulating substrate 2, the bonding area between the first lead terminal 220 and the first electrode 5B (the bonding area between the conductive bonding material J and the first electrode 5B) and the bonding area between the second lead terminal 230 and the second electrode 6B (the bonding area between the conductive bonding material J and the second electrode 6B) can be increased. Thus, the bonding strength of the first lead terminal 220 to the first electrode 5B and the bonding strength of the second lead terminal 230 to the second electrode 6B can be increased. Therefore, according to the example of the third embodiment, the connection reliability of the battery module 100B can be further improved.

In the case where the first electrode 5B and the second electrode 6B extend on the bottom surface of the recessed portion 21 of the insulating substrate 2, the bonding area between the first lead terminal 220 and the first electrode 5B and the bonding area between the second lead terminal 230 and the second electrode 6B can be further increased. Thus, the bonding strength of the first lead terminal 220 to the first electrode 5B and the bonding strength of the second lead terminal 230 to the second electrode 6B can be increased. Therefore, according to the example of the third embodiment, the connection reliability of the battery module 100B can be improved.

When the first electrode 5B and the second electrode 6B are metal films located on the inner surfaces of the grooves 27, 28 of the insulating substrate 2, the bonding area between the first electrode 5B and the insulating substrate 2 and the bonding area between the second electrode 6B and the insulating substrate 2 can be increased. Thus, the bonding strength of the first electrode 5B to the insulating substrate 2 and the bonding strength of the second electrode 6B to the insulating substrate 2 can be increased. Therefore, according to the example of the third embodiment, the long-term reliability of the battery module 100B can be improved.

In addition, also in the example of the third embodiment, the above-described operation and effect related to avoidance of a short circuit due to dripping of the conductive bonding material J, the operational effect related to hermetic sealing, the operational effect related to the protrusion 22, and the operational effect related to the step portion 23 are achieved.

### Another Aspect of Third Embodiment

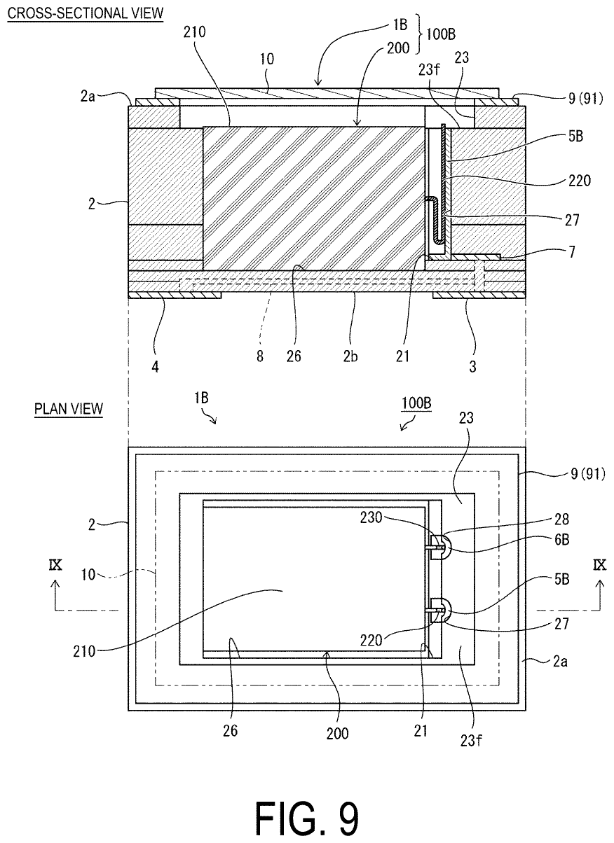

Another aspect of the battery package 1B and the battery module 100B according to the third embodiment will be described with reference to the cross-sectional view and the plan view of FIG. 9. The cross-sectional view of FIG. 9 is a schematic cross-sectional view taken along a line IX-IX in the plan view of FIG. 9. The plan view of FIG. 9 is a schematic plan view illustrating the battery module 100B according to another aspect of the third embodiment.

As in the example illustrated in the cross-sectional view and the plan view of FIG. 9, the lid body 10 made of metal may be bonded to the frame-shaped metal film 91 by welding such as seam welding, direct seam welding, laser welding, or electron beam welding. The bonding using the seam welding, the direct seam welding, the laser welding, or the electron beam welding is bonding by local heating of the bonding portion, and thus the influence of heat on the battery 200 is smaller than in the case of using brazing which is bonding by overall heating (reflow heating).

As in the example illustrated in the cross-sectional view and the plan view of FIG. 9, in the battery module 100B, the first lead terminal 220 may be electrically connected to the first electrode 5B in a state of being folded back and bent upward. The first lead terminal 220 may be electrically connected to the first electrode 5B in a state of being bent a plurality of times and inserted into the groove 27 of the insulating substrate 2. The second lead terminal 230 may be electrically connected to the second electrode 6B in a state of being folded and bent upward. The second lead terminal 230 may be electrically connected to the second electrode 6B in a state of being bent a plurality of times and inserted into the groove 28 of the insulating substrate 2.

As in the example illustrated in the cross-sectional view and the plan view of FIG. 9, when the first lead terminal 220 are electrically connected to the first electrode 5B in a state of being folded back and bent upward, the first lead terminal 220 can be brought into pressure contact with the first electrode 5B by their elastic forces without using the conductive bonding material J. When the second lead terminal 230 is electrically connected to the second electrode 6B in a state of being folded back and bent upward, the second lead terminal 230 can be brought into pressure contact with the second electrode 6B by their elastic forces without using the conductive bonding material J. Therefore, in the assembly work of the battery module 100B including the battery package 1B and the battery 200, the step of applying the conductive bonding material J can be omitted. Therefore, according to the example of another aspect of the third embodiment, the assemblability of the battery module 100B can be further improved.

The battery 200 may be bonded to the bottom surface of the recessed portion 21 of the insulating substrate 2 by a bonding material such as a resin adhesive. The battery 200 may be fixed by being pressed against the inner wall surface of the recessed portion 21 of the insulating substrate 2 by the elastic force of the first lead terminal 220 and the second lead terminal 230. When the elastic force (pressure contact force) of the first lead terminal 220 and the second lead terminal 230 is large, the bonding material for bonding the battery 200 to the bottom surface of the recessed portion 21 of the insulating substrate 2 can be omitted.

In another aspect of the third embodiment as well, the first lead terminal 220 may be bonded to the first electrode 5B with the conductive bonding material J. The second lead terminal 230 may be bonded to the second electrode 6B with the conductive bonding material J.

### Fourth Embodiment

A battery package 1C and a battery module 100C according to the fourth embodiment will be described with reference to the cross-sectional view and the plan view of FIG. 10. The cross-sectional view of FIG. 10 is a schematic cross-sectional view taken along a line X-X in the plan view of FIG. 10. The plan view of FIG. 10 is a schematic plan view illustrating the battery module 100C according to the fourth embodiment.

As in the example illustrated in the cross-sectional view and the plan view of FIG. 10, the battery package 1C according to the fourth embodiment includes the battery package 1C according to the fourth embodiment and the cylinder-type battery 200 mounted on the battery package 1C. The battery package 1C according to the fourth embodiment has the same configuration as the battery package 1 according to the first embodiment except for a part of the configuration. Among the configurations of the battery package 1C according to the fourth embodiment, configurations different from those of the battery package 1 according to the first embodiment will be described. For convenience of description, a member having the same function as that of a member described in the first embodiment is denoted by the same reference sign.

The battery package 1C includes a first electrode 5C located on the inner side surface of the recessed portion 21 of the insulating substrate 2, and the first electrode 5C corresponds to the first electrode 5 of the battery package 1. The first electrode 5C may extend along the lateral direction. The first electrode 5C is made of the same metallization metal powder as the first external electrode 3 and the like.

The battery package 1C includes a second electrode 6C located on the inner side surface of the recessed portion 21 of the insulating substrate 2, and corresponds to the second electrode 6 of the battery package 1. The second electrode 6C may extend along the lateral direction. The first electrode 5C and the second electrode 6C may be arranged in the depth direction of the recessed portion 21. The first electrode 5C and the second electrode 6C may extend in opposite directions. The second electrode 6C is made of the same metallization metal powder as the first external electrode 3 and the like.

Similarly to the first electrode 5, the first electrode 5C and the second electrode 6C are formed by being printed at predetermined positions of the ceramic green sheets for the insulating layers by a method such as a screen printing method. The surfaces of the first electrode 5C and the second electrode 6C exposed to the outside may be coated with a metal-plated layer such as a nickel-plated layer or a gold-plated layer by a plating method such as an electrolytic plating method or an electroless plating method.

The insulating substrate 2 may have a protrusion 22C located between the first electrode 5C and the second electrode 6C on the inner side surface of the recessed portion 21. In other words, the recessed portion 21 of the insulating substrate 2 may have the protrusion 22 located between the first electrode 5C and the second electrode 6C on the inner side surface thereof. The protrusion 22C of the insulating substrate 2 may extend along the lateral direction. The recessed portion 21 having the protrusion 22C is formed by appropriately punching a ceramic green sheet for an insulating layer.

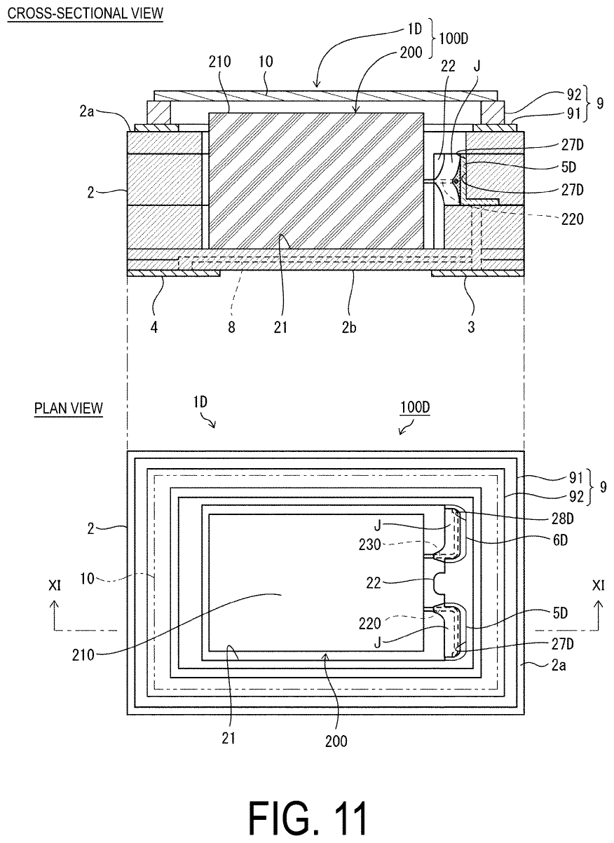

In the battery module 100C, the first lead terminal 220 may be electrically connected to the first electrode 5C in a state of being bent in the lateral direction. The second lead terminal 230 may be electrically connected to the second electrode 6C in a state of being bent in the lateral direction. The first lead terminal 220 and the second lead terminal 230 may be bent in the same direction, or may be bent in directions opposite to each other as indicated by a two-dot chain line in the example illustrated in FIG. 11. The first lead terminal 220 may be bonded to the first electrode 5C with the conductive bonding material J. The second lead terminal 230 may be bonded to the second electrode 6C with the conductive bonding material J.

The technique applied to the battery package 1 according to another aspect of the first embodiment of the example illustrated in FIG. 5 may be applied to the battery package 1C.

As in the example illustrated in the cross-sectional view and the plan view of FIG. 10, in the battery package 1C according to the fourth embodiment, the first electrode 5C and the second electrode 6C are located on the inner side surfaces of the recessed portion 21 of the insulating substrate 2. Therefore, when the cylinder-type battery 200 is accommodated in the recessed portion 21 of the insulating substrate 2 in a state where the first lead terminal 220 and the second lead terminal 230 are bent, the first lead terminal 220 and the second lead terminal 230 are electrically connected to the first electrode 5C and the second electrode 6C, respectively. Accordingly, the cylinder-type battery 200 can be mounted on the battery package 1C without adjusting the height of the bonding portion between the first lead terminal 220 and the first electrode 5C and the height of the bonding portion between the second lead terminal 230 and the second electrode 6C. Therefore, according to the example of the fourth embodiment, the assemblability of the battery module 100C including the battery package 1C and the battery 200 can be improved.

As described above, the cylinder-type battery 200 is accommodated in the recessed portion 21 of the insulating substrate 2 in a state where the first lead terminal 220 and the second lead terminal 230 are bent. Therefore, the size of the recessed portion 21 of the insulating substrate 2 in a plan view can be reduced by an amount corresponding to the bending of the first lead terminal 220 and the second lead terminal 230. Thus, according to the example of the fourth embodiment, the size of the battery package 1C can be reduced, in other words, the size of the battery module 100C can be reduced.

When the first electrode 5C and the second electrode 6C are arranged in the depth direction of the recessed portion 21, as described above, the conductive bonding material J drips from the first electrode 5C to the second electrode 6C, and there is a possibility of a short circuit between the first electrode 5C and the second electrode 6C. However, when the protrusion 22C is located between the first electrode 5C and the second electrode 6C on the inner side surface of the recessed portion 21 of the insulating substrate 2, even if the first electrode 5C and the second electrode 6C are arranged in the depth direction of the recessed portion 21, the likelihood of a short circuit between the first electrode 5C and the second electrode 6C due to dripping of the conductive bonding material J can be reduced.

In addition, also in the example of the fourth embodiment, the operational effect related to the operational effect related to the hermetic sealing described above is achieved.

### Fifth Embodiment

A battery package 1D and a battery module 100D according to the fifth embodiment will be described with reference to the cross-sectional view and the plan view of FIG. 11. The cross-sectional view of FIG. 11 is a schematic cross-sectional view taken along a line XI-XI in the plan view of FIG. 11. The plan view of FIG. 11 is a schematic plan view illustrating the battery module 100D according to the fifth embodiment.

As in the example illustrated in the cross-sectional view and the plan view of FIG. 11, the battery package 1D according to the fifth embodiment includes the battery package 1D according to the fifth embodiment and the cylinder-type battery 200 mounted on the battery package 1D. The battery package 1D according to the fifth embodiment has the same configuration as the battery package 1 according to the first embodiment except for a part of the configuration. Among the configurations of the battery package 1D according to the fifth embodiment, configurations different from those of the battery package 1 according to the first embodiment will be described. For convenience of description, a member having the same function as that of a member described in the first embodiment is denoted by the same reference sign.

The battery package 1D includes a first electrode 5D located on the inner side surface of the recessed portion 21 of the insulating substrate 2, and the first electrode 5D corresponds to the first electrode 5 of the battery package 1. The first electrode 5D may be a metal film located along the inner surface of a groove 27D having a wide shape exposed to the inner side surface of the recessed portion 21 of the insulating substrate 2. The groove 27D of the insulating substrate 2 may extend along the lateral direction and the depth direction of the recessed portion 21. The groove 27D of the insulating substrate 2 may extend to the opening side of the recessed portion 21. The first electrode 5D may extend along the lateral direction. The first electrode 5D and the second electrode 6D may extend in opposite directions. The first electrode 5D is made of the same metallization metal powder as the first external electrode 3 and the like. The shape of the groove 27D of the insulating substrate 2 is not limited to the wide shape.

The battery package 1D includes a second electrode 6D located on the inner side surface of the recessed portion 21 of the insulating substrate 2, and the second electrode 6D corresponds to the second electrode 6 of the battery package 1. The second electrode 6D may be a metal film formed along the inner surface of a groove 28D having a wide shape exposed to the inner side surface of the recessed portion 21 of the insulating substrate 2. The groove 28D of the insulating substrate 2 may extend along the lateral direction and the depth direction of the recessed portion 21. The second electrode 6D may extend along the lateral direction. The groove 28D of the insulating substrate 2 may extend to the opening side of the recessed portion 21. The first electrode 5D and the second electrode 6D may be arranged in the lateral direction. The second electrode 6D is made of the same metallization metal powder as the first external electrode 3 and the like. The shape of the groove 28D of the insulating substrate 2 is not limited to the wide shape.

The grooves 27D, 28D of the insulating substrate 2 are formed by appropriately punching a ceramic green sheet for an insulating layer. The first electrode 5D and the second electrode 6D are formed on the inner surfaces of the grooves 27D, 28D of the insulating substrate 2 by, for example, hole printing. The method of forming the first electrode 5D and the second electrode 6D is not limited to hole printing, and may be, for example, coating, vapor deposition, or another method. The surfaces of the first electrode 5D and the second electrode 6D exposed to the outside may be coated with a metal-plated layer such as a nickel-plated layer or a gold-plated layer by a plating method such as an electrolytic plating method or an electroless plating method.

The insulating substrate 2 may have a protrusion 22D located between the first electrode 5D and the second electrode 6D on the inner side surface of the recessed portion 21. In other words, the recessed portion 21 of the insulating substrate 2 may have the protrusion 22D located between the first electrode 5D and the second electrode 6D on the inner side surface thereof. The protrusion 22D of the insulating substrate 2 may extend along the depth direction of the recessed portion 21. The recessed portion 21 having the protrusion 22D is formed by appropriately punching a ceramic green sheet for an insulating layer. In the battery package 1D, the protrusion 22D may be omitted from the configuration of the insulating substrate 2.

As in the example illustrated in the cross-sectional view of FIG. 11, the step portion 23 of the insulating substrate 2 may be located closer to the opening side of the recessed portion 21 than the first electrode 5D and the second electrode 6D at the edge of the recessed portion 21.

As in the example illustrated in the cross-sectional view and the plan view of FIG. 11, in the battery module 100D, the first lead terminal 220 may be electrically connected to the first electrode 5C in a state of being bent and inserted into the groove 27D of the insulating substrate 2. The second lead terminal 230 may be electrically connected to the second electrode 6D in a state of being bent and inserted into the grooves 28D of the insulating substrate 2. The first lead terminal 220 and the second lead terminal 230 may be bent in opposite directions. The first lead terminal 220 may be bonded to the first electrode 5D with the conductive bonding material J. The second lead terminal 230 may be bonded to the second electrode 6D with the conductive bonding material J.

As in the example illustrated in the cross-sectional view and the plan view of FIG. 11, in the battery package 1D according to the fifth embodiment, the first electrode 5D and the second electrode 6D are located on the inner side surfaces of the recessed portion 21 of the insulating substrate 2. Therefore, when the cylinder-type battery 200 is accommodated in the recessed portion 21 of the insulating substrate 2 in a state where the first lead terminal 220 and the second lead terminal 230 are bent, the first lead terminal 220 and the second lead terminal 230 are electrically connected to the first electrode 5D and the second electrode 6D, respectively. Accordingly, the cylinder-type battery 200 can be mounted on the battery package 1D without adjusting the height of the bonding portion between the first lead terminal 220 and the first electrode 5D and the height of the bonding portion between the second lead terminal 230 and the second electrode 6D. Therefore, according to the example of the fifth embodiment, the assemblability of the battery module 100D including the battery package 1D and the battery 200 can be improved.

In particular, when the first lead terminal 220 and the second lead terminal 230 are respectively inserted into the grooves 27D, 28D of the insulating substrate 2, the first lead terminal 220 and the second lead terminal 230 can be easily positioned with respect to the insulating substrate 2. When the grooves 27D, 28D of the insulating substrate 2 extend to the opening side of the recessed portion 21, the first lead terminal 220 and the second lead terminal 230 can be easily inserted into the grooves 27D, 28D of the insulating substrate 2. Therefore, according to the example of the fifth embodiment, the assemblability of the battery module 100D can be further improved.

As described above, the cylinder-type battery 200 is accommodated in the recessed portion 21 of the insulating substrate 2 in a state where the first lead terminal 220 and the second lead terminal 230 are bent. Therefore, the size of the recessed portion 21 of the insulating substrate 2 in a plan view can be reduced by an amount corresponding to the bending of the first lead terminal 220 and the second lead terminal 230. In the case where the first lead terminal 220 and the second lead terminal 230 are respectively inserted into the inside of the grooves 27D, 28D of the insulating substrate 2, the size of the recessed portion 21 of the insulating substrate 2 in a plan view can be further reduced by the amount of insertion of the first lead terminal 220 and the second lead terminal 230. Thus, according to the example of the fifth embodiment, the size of the battery package 1B can be reduced, in other words, the size of the battery module 100B can be reduced.

When the first lead terminal 220 and the second lead terminal 230 are inserted into the grooves 27D, 28D of the insulating substrate 2, respectively, the first lead terminal 220 and the second lead terminal 230 are less likely to come into contact with each other. Thus, according to the example of the fifth embodiment, the likelihood of a short circuit between the first electrode 5D and the second electrode 6D can be reduced.

When the first lead terminal 220 is bonded to the first electrode 5D with the conductive bonding material J in a state where the first lead terminal 220 is inserted into the groove 27D of the insulating substrate 2, the bonding strength of the first lead terminal 220 to the first electrode 5D can be increased. When the second lead terminal 230 is bonded to the second electrode 6D with the conductive bonding material J in a state where the second lead terminal 230 is inserted into the groove 28D of the insulating substrate 2, the bonding strength of the second lead terminal 230 to the second electrode 6D can be increased. Therefore, according to the example of the fifth embodiment, the connection reliability of the battery module 100D can be improved.

When the first electrode 5D and the second electrode 6D are metal films located on the inner surface of the grooves 27D, 28D of the insulating substrate 2, respectively, the bonding area between the first electrode 5D and the insulating substrate 2 and the bonding area between the second electrode 6D and the insulating substrate 2 can be increased. Thus, the bonding strength of the first electrode 5D to the insulating substrate 2 and the bonding strength of the second electrode 6D to the insulating substrate 2 can be increased. Therefore, according to the example of the fifth embodiment, the long-term reliability of the battery module 100D can be improved.

In addition, also in the example of the fifth embodiment, the above-described operational effect related to the hermetic sealing, the operational effect related to the protrusion 22, and the operational effect related to the step portion 23 are achieved.

### Sixth Embodiment

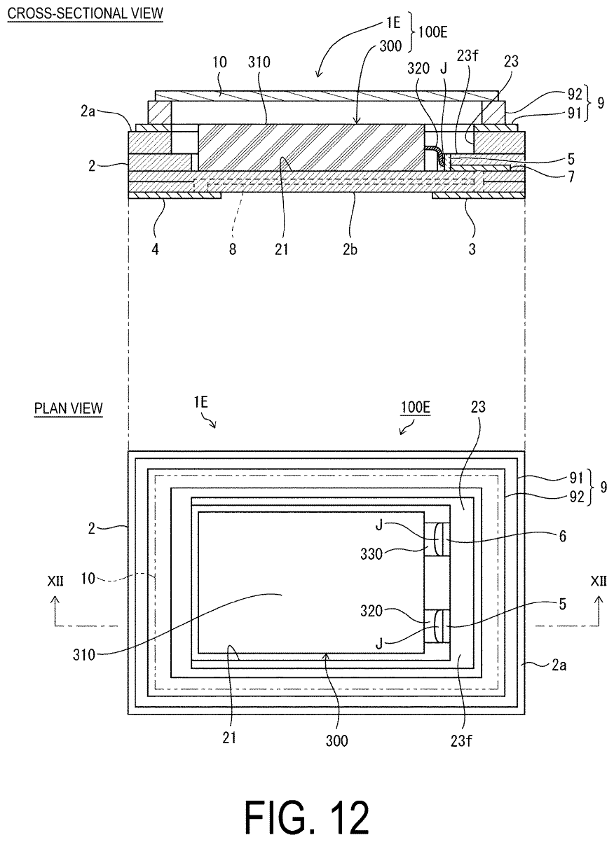

A battery module 100E according to the sixth embodiment will be described with reference to the cross-sectional view and the plan view of FIG. 12. The cross-sectional view of FIG. 12 is a schematic cross-sectional view taken along a line XII-XII in the plan view of FIG. 12. The plan view of FIG. 12 is a schematic plan view illustrating the battery module 100E according to the sixth embodiment.

As in the example illustrated in the cross-sectional view and the plan view of FIG. 12, the battery module 100E according to the sixth embodiment includes a battery package 1E according to the sixth embodiment and a laminate-type battery 300 mounted on the battery package 1E. The battery package 1E according to the sixth embodiment has the same configuration as that of the battery package 1 according to the first embodiment except that the size of the recessed portion 21 of the insulating substrate 2 corresponds to the size of the laminate-type battery 300.

The size of the recessed portion 21 of the insulating substrate 2 in a plan view is slightly larger than the size of a battery body 310 of the battery 300 in a plan view. The depth of the recessed portion 21 may be substantially the same as the thickness of the battery body 310 of the battery 300. The shape of the recessed portion 21 of the insulating substrate 2 in a plan view is not limited to a rectangular shape, and can be changed according to the shape of the battery body 210 of the battery 300.

The laminate-type battery 300 may be bonded to the bottom surface of the recessed portion 21 of the insulating substrate 2 by a bonding material such as a resin adhesive. The laminate-type battery 300 includes the battery body 310, and a first lead terminal 320 having a plate shape and a second lead terminal 330 having a plate shape which protrude from one side of the battery body 310. The battery body 310 may have a rectangular shape in a plan view.

The first lead terminal 320 may be electrically connected to the first electrode 5 in a state of being bent downward. The second lead terminal 330 may be electrically connected to the second electrode 6 in a state of being bent downward. The first lead terminal 320 and the second lead terminal 330 may be bent so as to be in pressure contact with the first electrode 5 and the second electrode 6, respectively, by elastic force. The first lead terminal 320 may be bonded to the first electrode 5 with the conductive bonding material J such as solder or a conductive resin. The second lead terminal 330 may be bonded to the second electrode 6 with the conductive bonding material J.

As in the example illustrated in the cross-sectional view and the plan view of FIG. 12, in the battery package 1, the first electrode 5 and the second electrode 6 are located on the inner side surface of the recessed portion 21 of the insulating substrate 2. Therefore, when the laminate-type battery 300 is accommodated in the recessed portion 21 of the insulating substrate 2 in a state where the first lead terminal 220 and the second lead terminal 230 are bent, the first lead terminal 320 and the second lead terminal 330 are electrically connected to the first electrode 5 and the second electrode 6, respectively. Accordingly, the laminate-type battery 300 can be mounted on the battery package 1 without adjusting the height of the bonding portion (connection portion) between the first lead terminal 320 and the first electrode 5 and the height of the bonding portion between the second lead terminal 330 and the second electrode 6. Therefore, according to the example of the sixth embodiment, the assemblability of the battery module 100E including the battery package 1 and the battery 300 can be improved.

As described above, the laminate-type battery 300 is accommodated in the recessed portion 21 of the insulating substrate 2 in a state where the first lead terminal 320 and the second lead terminal 330 are bent in the recessed portion 21. Therefore, the size of the recessed portion 21 of the insulating substrate 2 in a plan view can be reduced by an amount corresponding to the bending of the first lead terminal 320 and the second lead terminal 330. As a result, according to the example of the sixth embodiment, the size of the battery package 1 can be reduced, in other words, the size of the battery module 100E can be reduced.

In addition, according to the example of the sixth embodiment, the same operational effect as the example of the first embodiment described above is achieved.

### Another Aspect of Sixth Embodiment

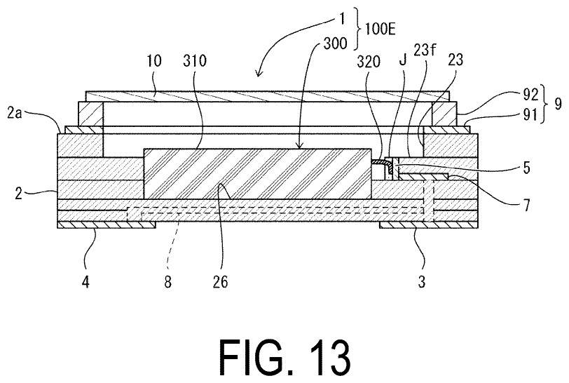

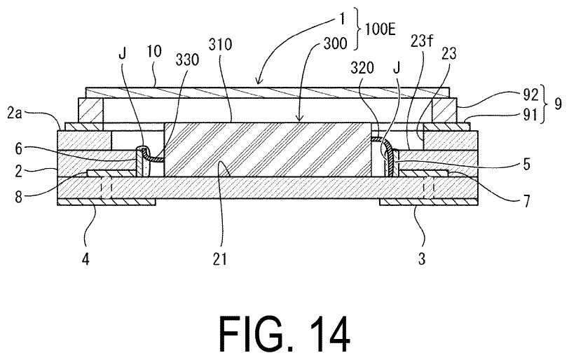

The battery module 100E according to another aspect of the sixth embodiment will be described with reference to FIGS. 13 and 14. FIGS. 13 and 14 are schematic plan views of a battery module 100E according to another aspect of the sixth embodiment.

As in the example illustrated in FIG. 13, the insulating substrate 2 may have the second recessed portion 26 exposed to the bottom surface of the recessed portion 21. The second recessed portion 26 of the insulating substrate 2 is a recessed portion which can be engaged with a lower portion which is a part of the battery body 310 of the laminate-type battery 300. The shape of the second recessed portion 26 of the insulating substrate 2 in a plan view may be, for example, a rectangular shape. The inner side surface of the second recessed portion 26 of the insulating substrate 2 may be parallel to the thickness direction of the insulating substrate 2. The size of the second recessed portion 26 of the insulating substrate 2 in a plan view corresponds to the size of the battery body 310 of the battery 300. The shape of the second recessed portion 26 of the insulating substrate 2 in a plan view is not limited to a rectangular shape, and can be changed in accordance with the shape of the battery body 310 of the battery 300.

The laminate-type battery 300 in the battery module 100E is accommodated in the recessed portion 21 of the insulating substrate 2 in a state where the lower portion of the battery body 310 is engaged with the second recessed portion 26 of the insulating substrate 2. The laminate-type battery 300 may be bonded to the bottom surface of the second recessed portion 26 of the insulating substrate 2 with a bonding material such as a resin adhesive.

As in the example illustrated in FIG. 14, when the insulating substrate 2 has the second recessed portion 26, the laminate-type battery 300 can be easily positioned with respect to the insulating substrate 2 by engaging the lower portion of the battery body 310 with the second recessed portion 26 of the insulating substrate 2. Thus, according to the example of another aspect of the sixth embodiment, the assemblability of the battery module 100E can be further improved.

As in the example illustrated in FIG. 14, in the case where the first lead terminal 320 and the second lead terminal 330 protrude from both sides of the battery body 310, the first electrode 5 and the second electrode 6 may be located on the opposing surfaces of the inner side surface of the recessed portion 21 of the insulating substrate 2. The first lead terminal 320 and the second lead terminal 330 may be bent in opposite directions to each other, or may be bent in the same direction.

### Seventh Embodiment

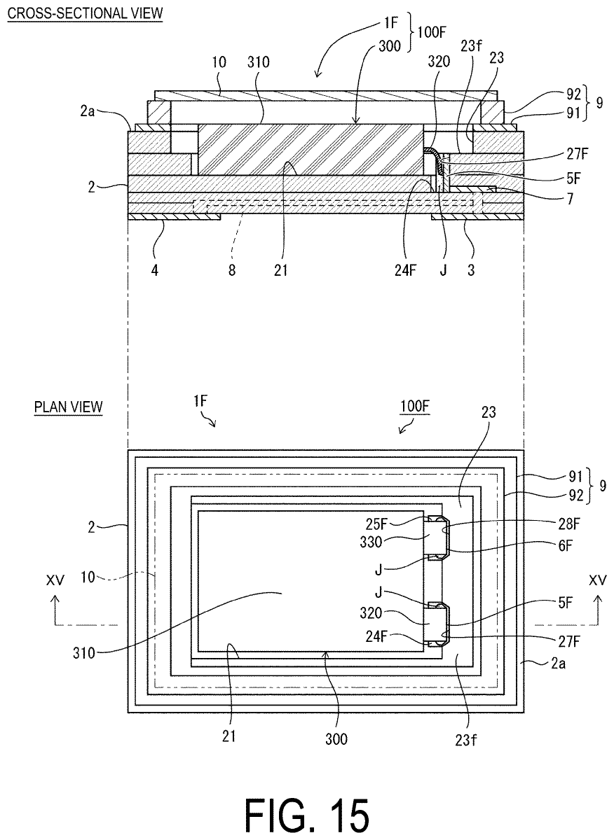

A battery package 1F and a battery module 100F according to the seventh embodiment will be described with reference to the cross-sectional view and the plan view of FIG. 15. The cross-sectional view of FIG. 15 is a schematic cross-sectional view taken along a line XV-XV in the plan view of FIG. 15. The plan view of FIG. 15 is a schematic plan view illustrating the battery module 100F according to the seventh embodiment.

As in the example illustrated in the cross-sectional view and the plan view of FIG. 15, the battery package 1F according to the seventh embodiment includes the battery package 1F according to the seventh embodiment and the laminate-type battery 300 mounted on the battery package 1F. The battery package 1F according to the seventh embodiment has the same configuration as the battery package 1E except for a part of the configuration. Among the configurations of the battery package 1F according to the seventh embodiment, configurations different from those of the battery package 1E will be described. For convenience of description, members having the same functions as the members described in the sixth embodiment are denoted by the same reference numerals.

The battery package 1F includes a first electrode 5F located on the inner side surface of the recessed portion 21 of the insulating substrate 2, and the first electrode 5F corresponds to the first electrode 5 of the battery package 1E. The first electrode 5F may be a metal film located along the inner surface of a groove 27F having a wide shape exposed to the inner side surface of the recessed portion 21 of the insulating substrate 2. The groove 27F of the insulating substrate 2 may extend along the depth direction of the recessed portion 21. The groove 27F of the insulating substrate 2 may extend to the opening side of the recessed portion 21. The first electrode 5F may extend along the depth direction of the recessed portion 21. The first electrode 5F may extend to the upper end of the groove 27F of the insulating substrate 2. The first electrode 5F may extend to the height position of the bottom surface of the recessed portion 21 of the insulating substrate 2. The first electrode 5F is made of the same metallization metal powder as the first external electrode 3 and the like. The shape of the groove 27F of the insulating substrate 2 is not limited to the wide shape.

The battery package 1F includes a second electrode 6F located on the inner side surface of the recessed portion 21 of the insulating substrate 2, and the second electrode 6F corresponds to the second electrode 6 of the battery package 1E. The second electrode 6F may be a metal film formed along the inner surface of a groove 28F having a wide shape exposed to the inner side surface of the recessed portion 21 of the insulating substrate 2. The groove 28F of the insulating substrate 2 may extend along the depth direction of the recessed portion 21. The groove 28F of the insulating substrate 2 may extend along the depth direction of the recessed portion 21. The second electrode 6F may extend along the depth direction of the recessed portion 21. The second electrode 6F may extend to the upper end of the groove 28F of the insulating substrate 2. The second electrode 6F may extend to the height position of the bottom surface of the recessed portion 21 of the insulating substrate 2. The first electrode 5F and the second electrode 6F may be arranged in the lateral direction. The second electrode 6F is made of the same metallization metal powder as the first external electrode 3 and the like. The shape of the groove 28F of the insulating substrate 2 is not limited to the wide shape.

The grooves 27F, 28F of the insulating substrate 2 are formed by appropriately punching a ceramic green sheet for an insulating layer. The first electrode 5F and the second electrode 6F are formed on the inner surfaces of the grooves 27F, 28F of the insulating substrate 2 by, for example, hole printing. The method of forming the first electrode 5F and the second electrode 6F is not limited to hole printing, and may be, for example, coating, vapor deposition, or another method. The surfaces of the first electrode 5F and the second electrode 6F exposed to the outside may be coated with a metal-plated layer such as a nickel-plated layer or a gold-plated layer by a plating method such as an electrolytic plating method or an electroless plating method.

As in the example illustrated in the cross-sectional view and the plan view of FIG. 15, the insulating substrate 2 may have depressions 24F, 25F and located at positions corresponding to the first electrode 5F and the second electrode 6F, respectively, on the bottom surface of the recessed portion 21. A depression 24F of the insulating substrate 2 may dam the conductive bonding material J for bonding the first lead terminal 320 to the first electrode 5F (hereinafter referred to as the conductive bonding material J for the first lead terminal 320). A depression 25f of the insulating substrate 2 may dam the conductive bonding material J for bonding the second lead terminal 330 to the second electrode 6F (hereinafter referred to as the conductive bonding material J for the second lead terminal 330). The depressions 24F, 25F of the insulating substrate 2 are formed by appropriately punching a ceramic green sheet for an insulating layer. The first electrode 5F may extend to the inside of the depression 24F of the insulating substrate 2. The second electrode 6F may extend to the inside of the depression 25F of the insulating substrate 2.

The first electrode 5F may extend to the inner side surface of the depression 24F continuous with the inner side surface of the recessed portion 21 of the insulating substrate 2. The first electrode 5F may extend to the bottom surface of the depression 24F of the insulating substrate 2. The second electrode 6F may extend to the inner side surface of the depression 25F continuous with the inner side surface of the recessed portion 21 of the insulating substrate 2. The second electrode 6F may extend to the bottom surface of the depression 25 of the insulating substrate 2.

As in the example illustrated in the cross-sectional view and the plan view of FIG. 15, in the battery module 100F, the first lead terminal 320 may be electrically connected to the first electrode 5B in a state of being bent downward and inserted into the groove 27F of the insulating substrate 2. The second lead terminal 230 may be bent downward and inserted into the groove 28 of the insulating substrate 2 to be electrically connected to the second electrode 6B. The first lead terminal 320 may be bonded to the first electrode 5B with the conductive bonding material J. The second lead terminal 330 may be bonded to the second electrode 6B with the conductive bonding material J.

The technique applied to the battery module 100F according to another aspect of the sixth embodiment of the example illustrated in FIG. 3 may be applied to the battery module 100E.

As in the example illustrated in the cross-sectional view and the plan view of FIG. 15, in the battery package 1F according to the seventh embodiment, the first electrode 5F and the second electrode 6F are located on the inner side surfaces of the recessed portion 21 of the insulating substrate 2. Therefore, when the laminate-type battery 300 is accommodated in the recessed portion 21 of the insulating substrate 2 in a state where the first lead terminal 320 and the second lead terminal 330 are bent, the first lead terminal 320 and the second lead terminal 330 are electrically connected to the first electrode 5F and the second electrode 6F, respectively. Accordingly, the laminate-type battery 300 can be mounted on the battery package 1F without adjusting the height of the bonding portion between the first lead terminal 320 and the first electrode 5F and the height of the bonding portion between the second lead terminal 330 and the second electrode 6F. Therefore, according to the example of the seventh embodiment, the assemblability of the battery module 100F including the battery package 1F and the battery 200 can be improved.

In particular, when the first lead terminal 320 and the second lead terminal 330 are respectively inserted into the grooves 27F, 28F of the insulating substrate 2, the first lead terminal 320 and the second lead terminal 330 can be easily positioned with respect to the insulating substrate 2. When the grooves 27F, 28F of the insulating substrate 2 extend to the opening side of the recessed portion 21, the first lead terminal 320 and the second lead terminal 330 can be easily inserted into the grooves 27F, 28F of the insulating substrate 2. Thus, according to the example of the seventh embodiment, the assemblability of the battery module 100F can be further improved.

As described above, the laminate-type battery 300 is accommodated in the recessed portion 21 of the insulating substrate 2 in a state where the first lead terminal 320 and the second lead terminal 330 are bent. Therefore, the size of the recessed portion 21 of the insulating substrate 2 in a plan view can be reduced by an amount corresponding to the bending of the first lead terminal 320 and the second lead terminal 330. In the case where the first lead terminal 320 and the second lead terminal 330 are inserted into the grooves 27F, 28F of the insulating substrate 2, respectively, the size of the recessed portion 21 of the insulating substrate 2 in a plan view can be further reduced by the insertion of the first lead terminal 320 and the second lead terminal 330. As a result, according to the example of the seventh embodiment, the size of the battery package 1F, in other words, the size of the battery module 100F can be reduced.

When the first lead terminal 320 and the second lead terminal 330 are inserted into the grooves 27F, 28F of the insulating substrate 2, respectively, the first lead terminal 320 and the second lead terminal 330 are less likely to come into contact with each other. Thus, according to the example of the seventh embodiment, the likelihood of a short circuit between the first electrode 5F and the second electrode 6F can be reduced.

When the first lead terminal 320 is bonded to the first electrode 5F with the conductive bonding material J in a state where the first lead terminal 320 is inserted into the groove 27F of the insulating substrate 2, the bonding strength of the first lead terminal 220 to the first electrode 5F can be increased. When the second lead terminal 330 is bonded to the second electrode 6F with the conductive bonding material J in a state where the second lead terminal 330 is inserted into the groove 28F of the insulating substrate 2, the bonding strength of the second lead terminal 330 to the second electrode 6F can be increased. Therefore, according to the example of the seventh embodiment, the connection reliability of the battery module 100F can be improved.

In particular, when the first electrode 5F and the second electrode 6F extend to the bottom surfaces of the depressions 24F, 25F of the insulating substrate 2, respectively, the bonding area between the first lead terminal 320 and the first electrode 5F (the bonding area between the conductive bonding material J and the first electrode 5F) and the bonding area between the second lead terminal 330 and the second electrode 6F (the bonding area between the conductive bonding material J and the second electrode 6F) can be increased. Thus, the bonding strength of the first lead terminal 320 to the first electrode 5F and the bonding strength of the second lead terminal 330 to the second electrode 6F can be further increased. Therefore, according to the example of the seventh embodiment, the connection reliability of the battery module 100F can be further improved.

When the wiring layer of the first connection wiring line 7 extends from the first electrode 5B side to the bottom surface of the depression 24F of the insulating substrate 2, the first lead terminal 320 is bonded to the first electrode 5F and a part of the wiring layer of the first connection wiring line 7. When the wiring layer of the second connection wiring line 8 extends from the side of the second electrode 6B to the bottom surface of the depression 25F of the insulating substrate 2, the second lead terminal 330 is bonded to the second electrode 6F and a part of the wiring layer of the second connection wiring line 8. Thus, the bonding strength of the first lead terminal 320 to the first electrode 5F and the bonding strength of the second lead terminal 330 to the second electrode 6F can be increased. Therefore, according to the example of the seventh embodiment, the connection reliability of the battery module 100F can be improved.

When the first electrode 5F and the second electrode 6F are metal films located on the inner surface of the grooves 27F, 28F of the insulating substrate 2, respectively, the bonding area between the first electrode 5F and the insulating substrate 2 and the bonding area between the second electrode 6F and the insulating substrate 2 can be increased. Thus, the bonding strength of the first electrode 5F to the insulating substrate 2 and the bonding strength of the second electrode 6F to the insulating substrate 2 can be increased. Therefore, according to the example of the seventh embodiment, the long-term reliability of the battery module 100F can be improved.

When the insulating substrate 2 has the depressions 24F, 25F, the conductive bonding material J for the first lead terminal 320 and the conductive bonding material J for the second lead terminal 330 are less likely to come into contact with each other on the bottom surface of the recessed portion 21 of the insulating substrate 2. Thus, according to the example of the seventh embodiment, the likelihood of a short circuit between the first electrode 5F and the second electrode 6F due to the conductive bonding material J which spreads on the bottom surface of the recessed portion 21 of the insulating substrate 2 can be reduced.

In addition, according to the example of the seventh embodiment, the same operational effect as the example of the sixth embodiment described above is achieved.

### Other Embodiments

The number of batteries 200 (300) accommodated in the recessed portion 21 of the insulating substrate 2 is not limited to one, and may be two or more. A plurality of batteries 200 (300) may be arranged and accommodated in one recessed portion 21 of the insulating substrate 2 along the lateral direction. In this case, a plurality of sets of the first electrode 5 and the second electrode 6 are located on the inner side surface of one recessed portion 21. Alternatively, a plurality of recessed portions 21 may be positioned along the lateral direction on the first surface 2a of the insulating substrate 2, and the batteries 200 (300) may be accommodated in the plurality of recessed portions 21, respectively. In this case, the first electrode 5 and the second electrode 6 are located on the inner side surface of each recessed portion 21 of the insulating substrate 2.

A battery control semiconductor element for controlling the battery 200 (300) may be accommodated in the recessed portion 21 of the insulating substrate 2. The semiconductor elements for battery control include a DC/DC converter that supplies a constant power supply voltage, a reset 1C that monitors the power supply, and a switch 1C that turns the power supply on and off. For example, electronic components such as a coil and a capacitor may be accommodated in the recessed portion 21 of the insulating substrate 2. Such semiconductor elements and electronic components may be accommodated in a recessed portion different from the recessed portion 21 that accommodates the batteries 200 (300), for example, a recessed portion that opens on the second surface 2b of the insulating substrate 2.

The battery module 100 (100A to 100F) may include a drying agent that absorbs moisture. The desiccant may be located on the lower surface of the lid body 10. The drying agent may be located between the inner side surface of the recessed portion 21 of the insulating substrate 2 and the outer surface of the battery body 210 (310). For example, silica gel, calcium chloride, or the like may be used as the drying agent. In the case where the battery module 100 (100A to 100F) includes a drying agent, the deterioration of the battery material of the battery 200 (300) due to chemical changes with moisture can be suppressed.

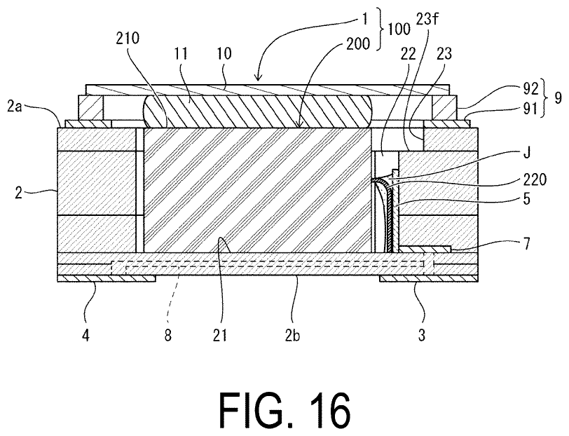

As in the example illustrated in FIG. 16, the battery module 100 may include an elastic body 11 interposed between the lower surface of the lid body 10 and the upper surface of the battery body 210. The elastic body 11 may fix the battery 200 to the insulating substrate 2 by its elastic force. Each of the battery modules 100A to 100F may include an elastic body 11 interposed between the lower surface of the lid body 10 and the upper surface of the battery body 210 (310). The elastic body 11 may fix the battery 200 (300) to the insulating substrate 2 by its elastic force. As the elastic body 11, a spring member such as a coil spring or a plate spring may be used, or rubber or the like may be used.

In the present disclosure, the invention has been described above based on the various drawings and examples. However, the invention according to the present disclosure is not limited to the above-described embodiments. That is, the embodiments of the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, a person skilled in the art can easily make various variations or modifications based on the present disclosure. Note that these variations or modifications are included within the scope of the present disclosure.

### REFERENCE SIGNS

1 Battery package (battery package according to first embodiment)
2 Insulating substrate
21 Recessed portion
22 Protrusion
23 Step portion
23f Step surface
24 Depression
25 Depression
26 Second recessed portion
3 First external electrode
4 Second external electrode
5 First electrode
6 Second electrode
7 First connection wiring line
8 Second connection wiring line
9 Frame portion
91 Frame-shaped metal film
92 Metal frame body
10 Lid body
100 Battery module (battery module according to first embodiment)
200 Cylinder-type battery
210 Battery body
220 First lead terminal
230 Second lead terminal
1A Battery package (battery package according to second embodiment)
27 Groove
28 Groove
5A First electrode
6A Second electrode
100A Battery module (battery module according to second embodiment)
1B Battery package (battery package according to third embodiment)
5B First electrode
6B Second electrode
100B Battery module (battery module according to third embodiment)
1C Battery package (battery package according to fourth embodiment)
22C Protrusion
5C First electrode
6C Second electrode
100C Battery module (battery module according to fourth embodiment)
1D Battery package (battery package according to fifth embodiment)
22D Protrusion
5D First electrode
6D Second electrode
100D Battery module (battery module according to fifth embodiment)
1E Battery package (battery package according to sixth embodiment)
100E Battery module (battery module according to sixth embodiment)
300 Laminate-type battery
310 Battery body
320 First lead terminal
330 Second lead terminal
1F Battery package (battery package according to seventh embodiment)
5F First electrode
6F Second electrode
100F Battery module (battery module according to seventh embodiment)

1. A battery package comprising:
an insulating substrate comprising a first surface, a second surface located opposite to the first surface, and a recessed portion exposed in the first surface;
a first external electrode located on the second surface;
a second external electrode located on the second surface;
a first electrode located on an inner side surface of the recessed portion and electrically connected to the first external electrode; and
a second electrode located on the inner side surface of the recessed portion and electrically connected to the second external electrode.

2. The battery package according to claim 1, wherein
the first electrode and the second electrode are arranged in a lateral direction.

3. The battery package according to claim 2, wherein
each of the first electrode and the second electrode extends to a height position of a bottom surface of the recessed portion.

4. The battery package according to claim 2, wherein
the first electrode and the second electrode extend in opposite directions.

5. The battery package according to claim 2, wherein
each of the first electrode and the second electrode extends from a central portion in a depth direction of the recessed portion toward an opening side of the recessed portion.

6. The battery package according to claim 1, wherein
each of the first electrode and the second electrode is a metal body filled in a groove exposed to the inner side surface of the recessed portion.

7. The battery package according to claim 1, wherein
each of the first electrode and the second electrode is a metal film located along an inner surface of a groove exposed to the inner side surface of the recessed portion.

8. The battery package according to claim 2, wherein
the first electrode and the second electrode extend from the inner side surface to a bottom surface of the recessed portion.

9. The battery package according to claim 2, wherein
the insulating substrate comprises depressions located at positions corresponding to the first electrode and the second electrode on a bottom surface of the recessed portion.

10. The battery package according to claim 9, wherein
the first electrode and the second electrode each extend to an inner side of a corresponding one of the depressions.

11. The battery package according to claim 1, wherein
the insulating substrate comprises a protrusion located between the first electrode and the second electrode on the inner side surface of the recessed portion.

12. The battery package according to claim 5, wherein
the inner side surface on which the first electrode and the second electrode are located is inclined outward with respect to the depth direction of the recessed portion.

13. The battery package according to claim 1, further comprising:
a frame portion located surrounding the recessed portion on the first surface.

14. The battery package according to claim 13, wherein
the insulating substrate comprises a step portion at an edge portion of the recessed portion, and a step surface of the step portion is located at a position closer to an opening side of the recessed portion than the first electrode and the second electrode.

15. The battery package according to claim 1, wherein
the insulating substrate comprises a second recessed portion exposed to the bottom surface of the recessed portion.

16. The battery package according to claim 1, wherein
the insulating substrate is made of a ceramic.

17. A battery module comprising:
the battery package according to claim 1; and
a cylinder-type or laminate-type battery accommodated in the recessed portion and comprising a first lead terminal electrically connected to the first electrode in a bent state and a second lead terminal electrically connected to the second electrode in a bent state.

18. A battery module comprising:
the battery package according to claim 7; and
a cylinder-type or laminate-type battery accommodated in the recessed portion and comprising a first lead terminal electrically connected to the first electrode in a state of being bent and inserted into the groove, and a second lead terminal electrically connected to the second electrode in a state of being bent and inserted into the groove.

19. The battery module according to claim 17, wherein
the first lead terminal and the second lead terminal are bent to be brought into pressure contact with the first electrode and the second electrode, respectively, by an elastic force.
